(19) United States
(12) Patent Application Publication
(10) Pub. No.: US 2025/0052666 A1
(43) Pub. Date: Feb. 13, 2025

(54) DUAL FREQUENCY COMB IMAGING SPECTROSCOPIC ELLIPSOMETER

(71) Applicant: KLA Corporation, Milpitas, CA (US)

(72) Inventors: Chao Chang, San Jose, CA (US); Jongjin Kim, San Jose, CA (US); David Zimdars, Ann Arbor, MI (US)

(21) Appl. No.: 18/677,487

(22) Filed: May 29, 2024

Related U.S. Application Data
(60) Provisional application No. 63/531,473, filed on Aug. 8, 2023.

(51) Int. Cl. G01N 21/21; G01N 21/17; G01N 21/23; G01N 21/88

(52) U.S. Cl. CPC G01N 21/211; G01N 21/23; G01N 21/8806; G01N 2021/1765; G01N 2021/178; G01N 2021/1789; G01N 2021/213; G01N 2201/068; G01N 2201/11; G01N 2201/123

(57) ABSTRACT

A measurement system may direct an illumination beam including at least one of a first frequency comb or a second frequency comb to a sample, and generate a sequence of images of the sample based on the first frequency comb and the second frequency comb. The system may include one or more coding optical elements to encode data associated with one or more transfer matrix elements into the sequence of images of the sample. The system may further generate a transfer matrix dataset including measurements of at least one of the one or more transfer matrix elements associated with the sample based on at least one of spectral, spatial, or temporal analysis of the sequence of images, and generate one or more measurements of the sample based on the transfer matrix dataset.

### CROSS-REFERENCE TO RELATED APPLICATION

The present application claims the benefit under 35 U.S.C. § 119 (e) of U.S. Provisional Application Ser. No. 63/531,473, filed Aug. 8, 2023, entitled DUAL FREQUENCY COMB IMAGING SPECTROSCOPIC ELLIPSOMETER, naming Chao Chang, Jongjin Kim, and David Zimdars as inventors, which is incorporated herein by reference in the entirety.

### TECHNICAL FIELD

The present disclosure relates generally to spectroscopic ellipsometry and, more particularly, to imaging spectroscopic ellipsometry.

### BACKGROUND

Semiconductor manufacturing processes are getting incredibly complicated. For example, as nodes continuously scale in semiconductor devices, logic device fabrication techniques are moving from FinFET to Gate-All-Around (GAA) nanosheet, and will continue the trend from nanosheet to forksheet, from forksheet to complementary FET with 3D “folding” of nFET on top of pFET wire, and so on. As another example, DRAM fabrication techniques may eventually move to 3D-NAND like 3D-DRAM structure at same time that EUV adoption continuously drives down the current 2D-DRAM dimensions.

As a result, increased demands are being placed on metrology tools suitable for characterizing such small and complex structures. Mueller Matrix Spectroscopic Ellipsometry (MMSE) is one of the promising technologies since the Mueller matrix contains the information of polarization states changes after light interacts with the complex 3D structures patterned on the semiconductor wafer. However, traditional MMSE techniques fail to meet throughput and spot size requirements.

There is therefore a need to develop systems and methods to cure the above deficiencies.

### SUMMARY

In embodiments, the techniques described herein relate to a measurement system including a first frequency comb source configured to generate a first frequency comb; a second frequency comb source configured to generate a second frequency comb with a different repetition rate than the first frequency comb, where the second frequency comb source is at least one of frequency or phase-locked to the first frequency comb source; an illumination sub-system including one or more illumination lenses to direct an illumination beam including at least one of the first frequency comb or the second frequency comb to a sample; an imaging sub-system including one or more imaging lenses and a detector configured to generate a sequence of images of the sample based on the first frequency comb and the second frequency comb; one or more coding optical elements including at least one of one or more optical retarders or one or more polarizers, where at least one of the one or more coding optical elements is in the illumination sub-system, where at least one of the one or more coding optical elements is in the imaging sub-system, where the one or more coding optical elements encode data associated with one or more transfer matrix elements into the sequence of images of the sample, where the data associated with the one or more transfer matrix elements is encoded into at least one of a spatial domain, a spectral domain, or a time domain of the sequence of images; and a controller including one or more processors configured to execute program instructions causing the one or more processors to generate a transfer matrix dataset including measurements of at least one of the one or more transfer matrix elements associated with the sample based on at least one of spatial, spectral, or temporal analysis of the sequence of images, where the transfer matrix dataset is at least one of spatially, spectrally, or temporally resolved; and generate one or more measurements of the sample based on the transfer matrix dataset.

In embodiments, the techniques described herein relate to a measurement system, where generate the transfer matrix dataset including the measurements of at least one of the one or more transfer matrix elements associated with the sample based on at least one of spatial, spectral, or temporal analysis of the sequence of images includes decoding the at least one of the one or more transfer matrix elements from the sequence of images based on at least one of spatial, spectral, or frequency analysis of the sequence of images.

In embodiments, the techniques described herein relate to a measurement system, where the one or more transfer matrix elements include Mueller matrix elements.

In embodiments, the techniques described herein relate to a measurement system, where the one or more transfer matrix elements include Jones matrix elements.

In embodiments, the techniques described herein relate to a measurement system, where the illumination sub-system further includes a beam combiner configured to combine the first frequency comb and the second frequency comb into a single illumination beam, where the one or more imaging lenses of the illumination sub-system direct the single illumination beam to the sample.

In embodiments, the techniques described herein relate to a measurement system, where the sequence of images correspond to multi-pixel images of the sample, where the transfer matrix dataset includes the measurements of at least one of the one or more transfer matrix elements as a function of wavelength and spatial location on the sample.

In embodiments, the techniques described herein relate to a measurement system, where the sequence of images correspond to single-pixel images of the sample, where the transfer matrix dataset includes the measurements of at least one of the one or more transfer matrix elements as a function of wavelength for a single spatial location on the sample.

In embodiments, the techniques described herein relate to a measurement system, where the one or more coding optical elements include a generator in the illumination sub-system, the generator including one or more beam-shearing plates to generate two or more sheared beams with different polarization states, where the one or more illumination lenses of the illumination sub-system direct the two or more sheared beams to a common spot on the sample; and an analyzer in the imaging sub-system, the analyzer including one or more additional beam-shearing plates to shear the two or more sheared beams into additional sheared beams with different polarization states, where the one or more imaging lenses of the imaging sub-system interfere the additional sheared beams on the detector.

In embodiments, the techniques described herein relate to a measurement system, where generate the transfer matrix dataset including the measurements of at least one of the one or more transfer matrix elements associated with the sample based on at least one of spectral or spatial frequency analysis of the sequence of images includes generate, for a particular image of the sequence of images, one or more channel images based on a spatial frequency filtering technique; and generate one or more transfer matrix element datasets based on the one or more channel images, where the transfer matrix dataset includes the one or more transfer Matrix element datasets.

In embodiments, the techniques described herein relate to a measurement system, where the sequence of images includes multi-pixel images, where the one or more transfer matrix element datasets include a sequence of spatially-resolved transfer matrix element images; where generate the transfer matrix dataset including the measurements of at least one of the one or more transfer matrix elements associated with the sample based on at least one of a spatial, spectral, or temporal analysis of the sequence of images further includes extract, for at least some pixels in the sequence of images, spectrally-resolved transfer matrix element data using a temporal frequency analysis technique, where the transfer matrix dataset includes the spectrally-resolved transfer matrix element data.

In embodiments, the techniques described herein relate to a measurement system, where the one or more coding optical elements include a series of cascaded spectrally-dependent phase retarders to encode the data associated with the one or more transfer matrix elements into the spectral domain of the series of images.

In embodiments, the techniques described herein relate to a measurement system, where the measurements of at least one of the one or more transfer matrix elements for each location on the sample are decoded by spectral analysis of the sequence of images.

In embodiments, the techniques described herein relate to a measurement system, where the one or more coding optical elements include one or more rotating optical elements in at least one of the illumination sub-system or the imaging sub-system.

In embodiments, the techniques described herein relate to a measurement system, where the one or more rotating optical elements include a first rotating quarter waveplate in the illumination sub-system; and a second rotating quarter waveplate in the imaging sub-system, where the first rotating quarter waveplate and the second rotating quarter waveplate rotate at different speeds, where the data associated with the one or more transfer matrix elements is encoded into the time domain of the sequence of images.

In embodiments, the techniques described herein relate to a measurement system, where the measurements of at least one of the one or more transfer matrix elements for each location on the sample are decoded by temporal frequency analysis of the sequence of images.

In embodiments, the techniques described herein relate to a measurement system, where the imaging sub-system provides the sequence of images through electro-optical sampling.

In embodiments, the techniques described herein relate to a measurement system, where the one or more measurements include one or more metrology measurements.

In embodiments, the techniques described herein relate to a measurement system, where the one or more measurements include one or more inspection measurements.

In embodiments, the techniques described herein relate to a measurement system including a controller including one or more processors configured to execute program instructions causing the one or more processors to generate a transfer matrix dataset including measurements of one or more transfer matrix elements associated with a sample based on at least one of spatial, spectral or temporal analysis of a sequence of images, where the transfer matrix dataset is at least one of spatially resolved or spectrally resolved, where the sequence of images is generated by a measurement sub-system including a first frequency comb source configured to generate a first frequency comb; a second frequency comb source configured to generate a second frequency comb with a different repetition rate than the first frequency comb, where the second frequency comb source is at least one of frequency or phase-locked to the first frequency comb source; an illumination sub-system including one or more illumination lenses to direct an illumination beam including at least one of the first frequency comb or the second frequency comb to the sample; an imaging sub-system including one or more imaging lenses and a detector configured to generate the sequence of images of the sample based on the first frequency comb and the second frequency comb; and one or more coding optical elements including one or more optical retarders, where the one or more coding optical elements encode data associated with the one or more transfer matrix elements into the sequence of images of the sample, where the data associated with the one or more transfer matrix elements is encoded into at least one of a spatial domain, a spectral domain, or a time domain of the sequence of images; and generate one or more measurements of the sample based on the transfer matrix dataset.

In embodiments, the techniques described herein relate to a measurement system, where generate the transfer matrix dataset including the measurements of the one or more transfer matrix elements associated with the sample based on at least one of spatial, spectral, or temporal analysis of the sequence of images includes decoding the one or more transfer matrix elements from the sequence of images based on at least one of spatial, spectral, or frequency analysis of the sequence of images.

In embodiments, the techniques described herein relate to a measurement system, where the one or more transfer matrix elements include Mueller matrix elements.

In embodiments, the techniques described herein relate to a measurement system, where the one or more transfer matrix elements include Jones matrix elements.

In embodiments, the techniques described herein relate to a measurement system, where the illumination sub-system further includes a beam combiner configured to combine the first frequency comb and the second frequency comb into a single illumination beam, where the one or more imaging lenses of the illumination sub-system direct the single illumination beam to the sample.

In embodiments, the techniques described herein relate to a measurement system, where the sequence of images correspond to multi-pixel images of the sample, where the transfer matrix dataset includes the measurements of the one or more transfer matrix elements as a function of wavelength and spatial location on the sample.

In embodiments, the techniques described herein relate to a measurement system, where the sequence of images correspond to single-pixel images of the sample, where the transfer matrix dataset includes the measurements of the one or more transfer matrix elements as a function of wavelength for a single spatial location on the sample.

In embodiments, the techniques described herein relate to a measurement system, where the one or more coding optical elements include a generator in the illumination sub-system, the generator including one or more beam-shearing plates to generate two or more sheared beams with different polarization states, where the one or more illumination lenses of the illumination sub-system direct the two or more sheared beams to a common spot on the sample; and an analyzer in the imaging sub-system, the analyzer including one or more additional beam-shearing plates to shear the two or more sheared beams into additional sheared beams with different polarization states, where the one or more imaging lenses of the imaging sub-system interfere the additional sheared beams on the detector.

In embodiments, the techniques described herein relate to a measurement system, where generate the transfer matrix dataset including the measurements of the one or more transfer matrix elements associated with the sample based on at least one of spectral or spatial frequency analysis of the sequence of images includes generate, for a particular image of the sequence of images, one or more channel images based on a spatial frequency filtering technique; and generate one or more transfer matrix element datasets based on the one or more channel images, where the transfer matrix dataset includes the one or more transfer Matrix element datasets.

In embodiments, the techniques described herein relate to a measurement system, where the sequence of images includes multi-pixel images, where the one or more transfer matrix element datasets include a sequence of spatially-resolved transfer matrix element images; where generate the transfer matrix dataset including the measurements of the one or more transfer matrix elements associated with the sample based on at least one of spatial, spectral, or temporal analysis of the sequence of images further includes extract, for at least some pixels in the sequence of images, spectrally-resolved transfer matrix element data using a temporal frequency analysis technique, where the transfer matrix dataset includes the spectrally-resolved transfer matrix element data.

In embodiments, the techniques described herein relate to a measurement system, where the one or more coding optical elements include a series of cascaded spectrally-dependent phase retarders to encode the data associated with the one or more transfer matrix elements into the spectral domain of the series of images.

In embodiments, the techniques described herein relate to a measurement system, where the one or more transfer matrix elements for each location on the sample are decoded by spectral analysis of the sequence of images.

In embodiments, the techniques described herein relate to a measurement system, where the one or more coding optical elements include one or more rotating optical elements in at least one of the illumination sub-system or the imaging sub-system.

In embodiments, the techniques described herein relate to a measurement system, where the one or more rotating optical elements include a first rotating quarter waveplate in the illumination sub-system; and a second rotating quarter waveplate in the imaging sub-system, where the first rotating quarter waveplate and the second rotating quarter waveplate rotate at different speeds, where the data associated with the one or more transfer matrix elements is encoded into the time domain of the sequence of images.

In embodiments, the techniques described herein relate to a measurement system, where the one or more transfer matrix elements for each location on the sample are decoded by temporal frequency analysis of the sequence of images.

In embodiments, the techniques described herein relate to a measurement system, where the imaging sub-system provides the sequence of images through electro-optical sampling.

In embodiments, the techniques described herein relate to a measurement system, where the one or more measurements include one or more metrology measurements.

In embodiments, the techniques described herein relate to a measurement system, where the one or more measurements include one or more inspection measurements.

In embodiments, the techniques described herein relate to a measurement method including generating a transfer matrix dataset including measurements of one or more transfer matrix elements associated with a sample based on at least one of spatial, spectral, or temporal analysis of a sequence of images of the sample, where the transfer matrix dataset is at least one of spatially, spectrally, or temporally resolved, where the sequence of images is generated by a measurement sub-system including a first frequency comb source configured to generate a first frequency comb; a second frequency comb source configured to generate a second frequency comb with a different repetition rate than the first frequency comb, where the second frequency comb source is at least one of frequency or phase-locked to the first frequency comb source; an illumination sub-system including one or more illumination lenses to direct an illumination beam including at least one of the first frequency comb or the second frequency comb to the sample; an imaging sub-system including one or more imaging lenses and a detector configured to generate the sequence of images of the sample based on the first frequency comb and the second frequency comb; and one or more coding optical elements including one or more optical retarders, where the one or more coding optical elements encode data associated with the one or more transfer matrix elements into the sequence of images of the sample, where the data associated with the one or more transfer matrix elements is encoded into at least one of a spatial domain, a spectral domain, or a time domain of the sequence of images; and generating one or more measurements of the sample based on the transfer matrix dataset.

It is to be understood that both the foregoing general description and the following detailed description are exemplary and explanatory only and are not necessarily restrictive of the invention as claimed. The accompanying drawings, which are incorporated in and constitute a part of the specification, illustrate embodiments of the invention and together with the general description, serve to explain the principles of the invention.

### BRIEF DESCRIPTION OF DRAWINGS

The numerous advantages of the disclosure may be better understood by those skilled in the art by reference to the accompanying figures.

FIG. 1A illustrates a block diagram of a spectroscopic transfer matrix metrology system, in accordance with one or more embodiments of the present disclosure.

FIG. 1B illustrates a flow diagram illustrating steps performed in a method for generating at least one of spectrally or spatially resolved transfer matrix data, in accordance with one or more embodiments of the present disclosure.

FIG. 2 illustrates a schematic view of a metrology system, in accordance with one or more embodiments of the present disclosure.

FIG. 3A illustrates a schematic view of a BSP, in accordance with one or more embodiments of the present disclosure.

FIG. 3B illustrates a schematic view of a BSA, in accordance with one or more embodiments of the present disclosure.

FIG. 4 illustrates an optical chain of the metrology system with a generator prior to a sample and an analyzer after the sample, where both the generator and the analyzer are formed with a half-wave plate 316 as depicted in FIG. 3B, in accordance with one or more embodiments of the present disclosure.

FIG. 5 illustrates a simplified diagram of various channels within a spatial frequency plane of an image, in accordance with one or more embodiments of the present disclosure.

FIG. 6 illustrates different sampling regimes using dual frequency combs, in accordance with one or more embodiments of the present disclosure.

FIG. 7 illustrates a series of steps for generating spatially and spectrally resolved Mueller matrix data, in accordance with one or more embodiments of the present disclosure.

FIG. 8 illustrates a schematic view of a metrology system, in accordance with one or more embodiments of the present disclosure.

FIG. 9A illustrates a schematic view of a metrology system, in accordance with one or more embodiments of the present disclosure.

FIG. 9B illustrates an optical chain of the metrology system in FIG. 9A, in accordance with one or more embodiments of the present disclosure.

FIG. 10 illustrates a series of steps for generating spatially and spectrally resolved Mueller matrix data based on spectral coding, in accordance with one or more embodiments of the present disclosure.

FIG. 11 illustrates a schematic view of a metrology system, in accordance with one or more embodiments of the present disclosure.

FIG. 12 illustrates a schematic view of a metrology system, in accordance with one or more embodiments of the present disclosure.

FIG. 13A illustrates a schematic view of a metrology system, in accordance with one or more embodiments of the present disclosure.

FIG. 13B illustrates an optical chain of the metrology system depicted in FIG. 13A, in accordance with one or more embodiments of the present disclosure.

FIG. 14 illustrates a series of steps for generating spatially and spectrally resolved Mueller matrix data based on temporal polarization coding, in accordance with one or more embodiments of the present disclosure.

FIG. 15 illustrates a schematic view of a metrology system, in accordance with one or more embodiments of the present disclosure.

FIG. 16 illustrates a schematic view of a metrology system, in accordance with one or more embodiments of the present disclosure.

FIG. 17 illustrates a schematic view of a variation of the metrology system depicted in FIG. 2, in accordance with one or more embodiments of the present disclosure.

FIG. 18 illustrates a schematic view of a variation of the metrology system depicted in FIG. 9A, in accordance with one or more embodiments of the present disclosure.

FIG. 19 illustrates a schematic view of a variation of the metrology system depicted in FIG. 13A, in accordance with one or more embodiments of the present disclosure.

### DETAILED DESCRIPTION

Reference will now be made in detail to the subject matter disclosed, which is illustrated in the accompanying drawings. The present disclosure has been particularly shown and described with respect to certain embodiments and specific features thereof. The embodiments set forth herein are taken to be illustrative rather than limiting. It should be readily apparent to those of ordinary skill in the art that various changes and modifications in form and detail may be made without departing from the spirit and scope of the disclosure.

Embodiments of the present disclosure are directed to systems and methods providing an imaging metrology system with per-pixel transfer matrix spectroscopic ellipsometry measurements. As used herein, a transfer matrix may refer to any type of matrix describing a transformation of properties of light by a sample such as, but not limited to, a Mueller matrix or a Jones matrix. In this way, transfer matrix spectroscopic ellipsometry measurements are generated simultaneously for an entire imaged field (e.g., an image of the sample with one or more detectors located at a field plane conjugate to the sample) with pixel-level resolution to generate an on-the-fly metrology map. The imaged field may be adjusted to encompass a die, a sub-die region, or any selected spot size.

In embodiments, an imaging spectroscopic ellipsometry system includes one or more frequency comb generators to generate two frequency combs with different repetition rates, an imaging sub-system to image a sample with the two frequency combs, and one or more coding optical elements designed to code data associated with transfer matrix elements into images generated with the imaging sub-system in any combination of spatial, spectral, or temporal domains. Accordingly, transfer matrix elements as a function of wavelength (spectroscopic Mueller matrix metrology in the case of Mueller matrices) may be generated for each pixel or combinations of pixels through spectral, spatial, and/or temporal frequency analysis of the images based on the coding induced by the coding optical elements. For example, the coding elements may include a combination of optical retarders and/or polarizers located before and after the sample that code data associated with various transfer matrix elements, or combinations thereof, into the spatial, spectral, and/or temporal domains of the images such that spectroscopic transfer matrix data may be extracted based on corresponding spatial, spectral, and/or temporal techniques during post processing. Further, the imaging spectroscopic ellipsometry system may operate in a reflection mode or a transmission mode.

It is contemplated that the use of dual frequency combs combined with coding optical elements to provide may provide spectroscopic transfer matrix metrology with stationary elements. Put another way, dual frequency combs may provide spectroscopic transfer matrix metrology without requiring moving elements during detection. Such a configuration may thus provide stable and robust measurements. For example, directing dual frequency combs with different repetition rates to a sample may generate temporal beating signals that provide spectroscopic data similar to time-domain spectroscopy or dispersive Fourier transform spectroscopy in the time domain or heterodyne spectrometry in the frequency domain, where each pair of comb teeth contributes to the heterodyne signal at a specific radio frequency (RF) value.

It is further contemplated herein that the coding data associated with transfer matrix elements or combinations thereof into spatial, spectral, and/or temporal domains may be accomplished through numerous techniques within the spirit and scope of the present disclosure. As a result, it is to be understood that the specific examples disclosed herein are provided solely for illustrative purposes and should not be interpreted as limiting the scope of the present disclosure.

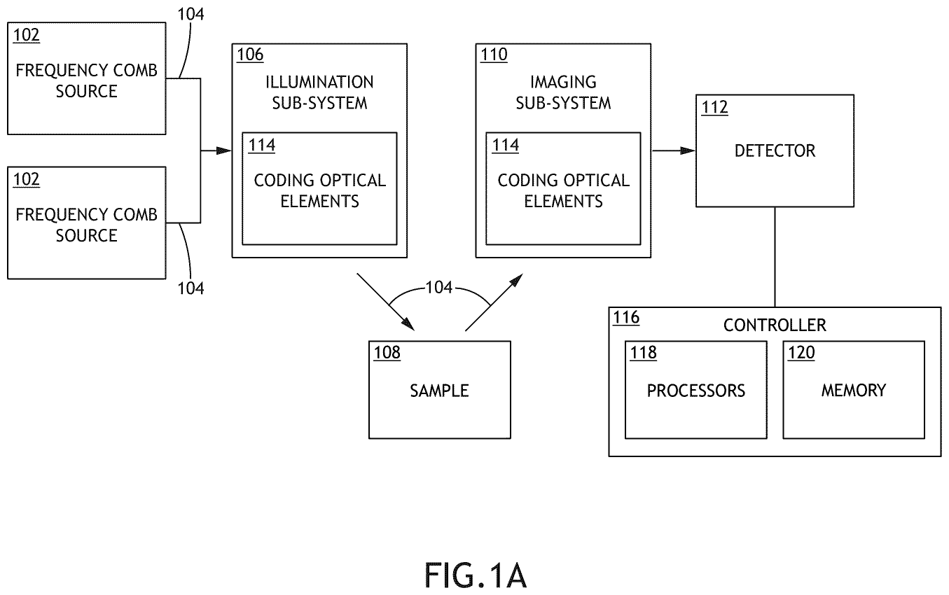

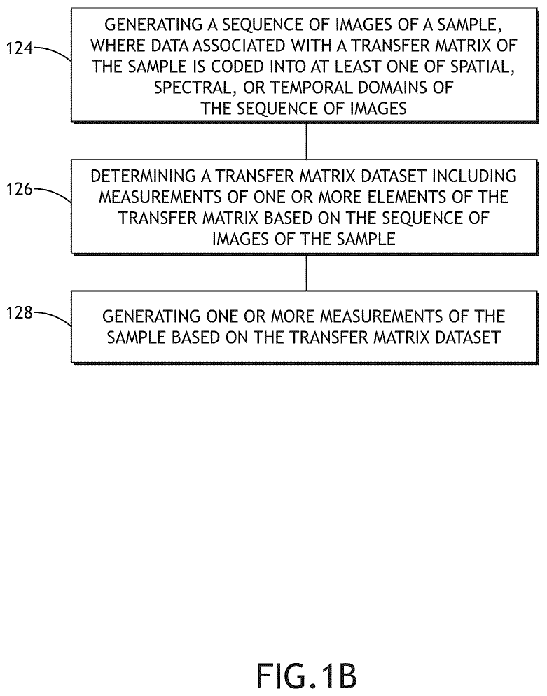

Referring now to FIGS. 1-19, systems and methods providing on-the-fly spectroscopic transfer matrix metrology are described, in accordance with one or more embodiments of the present disclosure.

FIG. 1A illustrates a block diagram of a metrology system 100 (e.g., a spectroscopic transfer matrix metrology system), in accordance with one or more embodiments of the present disclosure.

In embodiments, the metrology system 100 includes one or more frequency comb sources 102 to generate two phase-locked frequency combs 104 having different repetition rates, an illumination sub-system 106 to direct at least one of the two frequency combs 104 to a sample 108, an imaging sub-system 110 to collect light emanating from the sample 108, and a detector 112 located at an image plane to generate one or more images of the sample 108 based on the frequency combs 104. As used herein, an image of the sample 108 may refer to any data generated by a detector 112 at a field plane conjugate to the sample 108. Further, the detector 112 may include a single-pixel sensor or a multi-pixel sensor. For example, a single-pixel detector 112 located at a field plane may provide single-pixel image data associated with the sample 108 (e.g., a single-pixel image). As another example, a multi-pixel detector 112 located at a field plane may provide multi-pixel image data associated with the sample 108 (e.g., a multiple-pixel image).

The metrology system 100 may further include one or more coding optical elements 114 to code data associated with transfer matrix elements (e.g., Mueller matrix elements, Jones matrix elements, or the like) representative of the modification of light by the sample 108 into at least one of spatial, spectral, or time domains associated with a sequence of one or more images of the sample 108 captured by the detector 112.

The metrology system 100 may further include a controller 116 with one or more processors 118 configured to execute program instructions stored (e.g., maintained) on memory 120, or a memory device. Further, the controller 116 may be communicatively coupled to any components of the metrology system 100 such as, but not limited to, the detector 112. In this way, the one or more processors 118 of controller 116 may execute any of the various process steps described throughout the present disclosure either directly or indirectly. For example, the controller 116 may perform at least one of a spatial, spectral, or temporal analysis of the sequence of one or more images from the detector 112 to extract transfer matrix data associated with the sample 108. Put another way, the controller 116 may decode the transfer matrix data from the sequence of one or more images that was encoded by the coding optical elements 114. In particular, the controller 116 may generate transfer matrix elements as a function of wavelength (e.g., provide spectroscopic Mueller matrix metrology in the case of Mueller matrices) for each pixel or combinations of pixels. In this way, the controller 116 may generate on-the-fly spectroscopic transfer matrix metrology data for the sample with a spatial resolution associated with an image provided by the imaging sub-system 110.

A transfer matrix may represent how an object (e.g., the sample 108) modifies the polarization state of incident light. For example, the polarization state of light may be characterized by a four-element Stokes vector. A Mueller matrix is a 16-element transfer matrix representing the manipulation of a Stokes vector of light by the object. As another example, a Jones matrix may be a four-element transfer matrix representing a transformation of a Jones vector of incident and exiting light from a sample, where the Jones vector describes the amplitude and phase of the electric field of light in orthogonal directions.

In particular, Mueller matrix spectroscopic ellipsometry (MMSE) is a promising technique that uses collected Mueller matrix data to generate measurements associated with the physical and/or chemical structure of a target. Traditional MMSE techniques generate data associated with Mueller matrix of a target in whole or part based on a sequence of ellipsometry measurements in which the polarization states of incident and collected light are controlled through rotating polarizers and/or waveplates. However, such a technique is unsuitable for high-volume measurements due to a limited spatial resolution associated with the size of an illumination beam as well as a relatively low throughput associated with physical rotation of polarizing elements needed for the series of measurements.

In embodiments, the metrology system 100 generates spectrally and spatially resolved transfer matrix data associated with a sample 108 by encoding data indicative of transfer matrix elements into spatial, spectral, and/or temporal aspects of a series of images generated by the imaging sub-system 110 based on dual frequency combs 104 as an illumination source. In particular, one or more coding optical elements 114 of the metrology system 100 include polarization-manipulating optical elements to encode different polarization states into one or more frequency combs 104 used to image the sample 108 in any combination of spatial, spectral, or temporal domains. These coding optical elements 114 may be located anywhere in the metrology system 100 including in an illumination sub-system 106 to manipulate the frequency combs 104 prior to the sample 108 and/or in an imaging sub-system 110 to manipulate the frequency combs 104 after interaction with the sample 108. Notably, such a configuration may provide data associated with transfer matrix elements without requiring moving parts, which enables substantially higher throughput than existing MMSE techniques.

Broadly, the coding optical elements 114 may include any combination of one o or more polarization-manipulating elements such as, but not limited to waveplates or polarizers. In some embodiments, coding optical elements 114 include a beam-shearing plate (BSP) formed from two (or more) birefringent plates at different orientations to generate a spatially-varying polarization distribution. In some embodiments, coding optical elements 114 include a beam-shearing analyzer (BSA) formed from two (or more) BSPs separated by waveplates to further provide a spatially-varying polarization distribution. A combination of BSPs and/or BSAs to manipulate the polarization of light before and after interaction with the sample 108 may thus provide a spatial encoding of transfer matrix element data into one or more images of the sample 108. In particular, data associated with transfer matrix elements may be encoded into spatial frequencies of the image such that the data associated with specific transfer matrix elements (or combinations thereof) may be extracted using spatial-frequency filtering techniques (e.g., spatial-domain Fourier transform techniques) on an image.

Further, the use of dual frequency combs 104 combined with the coding optical elements 114 to provide may provide encoding of data associated with transfer matrix elements in the spectral and/or temporal domains. For example, the interaction of frequency combs 104 with different repetition rates may generate temporal beating signals that provide spectroscopic data similar to time-domain spectroscopy or dispersive Fourier transform spectroscopy in the time domain or heterodyne spectrometry in the frequency domain, where each pair of comb teeth contributes to the heterodyne signal at a specific radio frequency (RF) value.

In this way, spectrally-resolved data associated with transfer matrix elements (or combinations thereof) may be extracted from a sequence of images using temporal frequency analysis techniques (e.g., temporal Fourier transform techniques). Notably, such temporal frequency analysis may be applied to each pixel of a sequence of images to provide a spatially and spectrally resolved data associated with transfer matrix elements (or combinations thereof). This data may then be used to generate spatially resolved metrology measurements of the physical and/or chemical properties of the sample 108 with a resolution defined the imaging sub-system 110.

FIG. 1B illustrates a flow diagram illustrating steps performed in a method 122 for generating spectrally and/or spatially resolved transfer matrix data, in accordance with one or more embodiments of the present disclosure. The embodiments and enabling technologies described previously herein in the context of the metrology system 100 should be interpreted to extend to the method 122. For example, the processors 118 of the controller 116 of the metrology system 100 may execute program instructions causing the processors 118 to implement various steps of the method 122 either directly or indirectly (e.g., by generating control signals for directing additional components of the metrology system 100). As another example, various components of the metrology system 100 may implement various steps of the method 122. It is further noted, however, that the method 122 is not limited to the architecture of the metrology system 100.

In embodiments, the method 122 includes a step 124 of generating a sequence of images of the sample in which data associated with a transfer matrix (e.g., a Mueller matrix, a Jones matrix, or the like) of a sample is coded into at least one of spatial, spectral, or temporal domains of the sequence of images.

In embodiments, the method 122 includes a step 126 of generating a transfer matrix dataset including measurements of one or more elements of the transfer matrix (e.g., transfer matrix elements) based on the sequence of images. For example, the measurements of the transfer matrix elements may be generated based on at least one of spectral or spatial frequency analysis of a sequence of images. The transfer matrix dataset may be spectrally and/or spatially resolved. For example, the transfer matrix data may be formed as a tensor spatially-resolved images associated with values of one or more transfer matrix elements along one dimension and spectrally-resolved data associated with the one or more Mueller matrix elements along another dimension. As an illustration, the transfer matrix data for a Mueller matrix may be written as:

$${( \begin{matrix}{mm}_{00} & {mm}_{01} & {mm}_{02} & {mm}_{03} \\ {mm}_{10} & {mm}_{11} & {mm}_{12} & {mm}_{13} \\ {mm}_{20} & {mm}_{21} & {mm}_{22} & {mm}_{23} \\ {mm}_{30} & {mm}_{31} & {mm}_{32} & {mm}_{33}\end{matrix} )}_{( x , y , λ )} \qquad ( 1 )$$

where mmᵢⱼ correspond to individual transfer matrix elements, x and y are spatial coordinates, and λ represents wavelength (or spectral coordinates more generally).

However, it is noted that the transfer matrix data need not be spectrally and spatially resolved in all embodiments. In some embodiments, the transfer matrix data is only spectrally-resolved. For example, such a configuration may be generated with a single-pixel detector that generates single-pixel images. In some embodiments, the transfer matrix data is only spatially resolved. In this configuration, the transfer matrix data may be generated with a single wavelength.

In embodiments, the method 122 includes a step 128 of generating one or more measurements of the sample based on the transfer matrix dataset. Because the Mueller matrix data characterizes how the sample 108 manipulates the light, this transfer matrix data may be the basis of a wide range of measurements. For example, one or more models may relate the transfer matrix data to metrology measurements (e.g., perform a reverse measurement based on the transfer matrix data) such as, but not limited to, overlay measurements, critical dimension (CD) measurements, edge placement error (EPE) measurements, film metrology measurements (e.g., film thickness, refractive index, composition, or the like), local variation (e.g., mean) and/or locality (3-Sigma) measurements, pad measurements, or wafer edge to wafer center uniformity measurements (e.g., overlay, CD, or any other uniformity measurements). As another example, the transfer matrix data may be the basis of inspection measurements for defect identification and/or characterization.

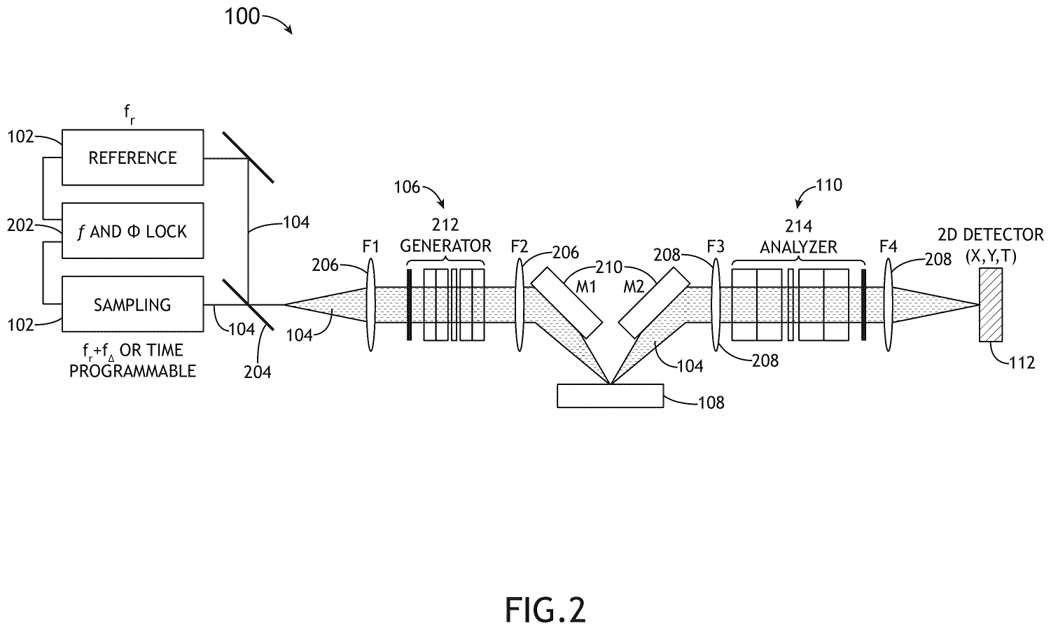

Referring now to FIGS. 2-17, various non-limiting configurations of the metrology system 100 are described, in accordance with one or more embodiments of the present disclosure. Broadly, it is contemplated herein that the metrology system 100 may include any combination of coding optical elements 114 suitable for coding data associated with one or more transfer matrix elements representing a sample 108 into spatial, spectral, and/or temporal properties of one or more images of the sample 108.

It is noted that FIGS. 2-17 focus on the use of a Mueller matrix as a transfer matrix. However, this is merely illustrative and should not be interpreted as limiting the scope of the present disclosure. Rather, the systems and methods disclosed herein may encode Jones matrix data in spatial, temporal, and/or spectral domains of a sequence of images of the sample 108 and then extract one or more Jones matrix elements associated with the sample 108 from the sequence of images.

The metrology system 100 may direct one or more of the frequency combs 104 to the sample 108. For example, in some embodiments, two frequency combs 104 are aligned to form a single collinear beam, which is directed to the sample 108. As another example, in some embodiments, a first frequency comb 104 is directed to the sample 108 and interfered with a second frequency comb 104 within the imaging sub-system 110 prior to the detector 112.

The detector 112 may include any sensor or combination of sensors located at an imaging plane suitable for capturing light associated with the frequency combs 104. In some embodiments, the detector 112 is a time-domain detector suitable for capturing time-domain signals in one or multiple pixels. For example, the detector 112 may include, but is not limited to, a photodiode or a photodiode array. Such a configuration may be suitable for generating spatially-resolved transfer matrix data. In some embodiments, the detector 112 is a single-pixel sensor such as, but not limited to, a photodetector. Such a configuration may generate transfer matrix data associated with one location on the sample (e.g., defined by a resolution of the imaging sub-system 110 in combination with a size of the detector 112), but may advantageously provide faster measurement speeds than a two-dimensional sensor. In this way, any references to images generated by a detector 112 herein may refer to single-pixel or multi-pixel images.

FIG. 2 illustrates a schematic view of a metrology system 100, in accordance with one or more embodiments of the present disclosure.

In FIG. 2, the metrology system 100 includes two phase-locked frequency comb sources 102 providing two frequency combs 104 with different frequencies, where the relative frequencies may be fixed (e.g., f and f+Δf) or programmable. The frequency comb sources 102 may include any combination of components suitable for generating a frequency comb 104 using any technique. Further, the frequency comb sources 102 may be provided as separate components coupled by a phase locker 202 or a may be provided as a single component.

In FIG. 2, the metrology system 100 includes a beamsplitter 204 to align and overlap the two frequency combs 104 along a colinear optical path. In this way, the two frequency comb sources 102 may be directed to the sample 108 as a single beam. However, this is merely an illustration and is not a requirement.

The illumination sub-system 106 and the imaging sub-system 110 may include any combination of optical elements suitable for directing one or more of the frequency combs 104 to the sample 108 and imaging the sample 108 based on the frequency combs 104. For example, FIG. 2 depicts a configuration where the illumination sub-system 106 includes a pair of illumination lenses 206 to focus the frequency combs 104 onto the sample 108 and where the imaging sub-system 110 includes a pair of collection lenses 208 to image the sample 108 onto the detector 112 (e.g., located at a field plane conjugate to the sample 108). It is noted that although FIG. 2 depicts the metrology system 100 as a reflection system (e.g., where the imaging sub-system 110 images light reflected by the sample 108, this is merely an illustration. In some embodiments, the metrology system 100 is a transmission system in which the imaging sub-system 110 images light transmitted through the sample. Further, FIG. 2 depicts mirrors 210 to manipulate the frequency combs 104 before and after the sample 108 to provide desired incidence and collection angles. Any incidence and collection angles may be provided such as, but not limited to, 65 degrees. The focal lengths of the illumination lenses 206 and the collection lenses 208 may be selected to provide any desired illumination spot size and/or imaging field of view. In some cases, the focal lengths of the illumination lenses 206 and the collection lenses 208 are selected to be equal (e.g., F1=F2=F3=F4). In some cases, the focal lengths of the illumination lenses 206 and the collection lenses 208 are selected to be complementary (e.g., F1=F4; F2=F3). In some cases, the focal lengths of the illumination lenses 206 and the collection lenses 208 are selected to have different values according to application requirements.

Further, FIG. 2 depicts a configuration with a two-dimensional detector 112 (e.g., a detector 112 with a multi-pixel sensor). FIG. 2 is thus suitable for providing a sequence of images as a three-dimensional dataset, where each image provides spatial data (e.g., data in x and y dimensions) and the sequence of images provides temporal data (e.g., t). Together, this dataset may be represented as (x,y,t).

Various aspects of the temporal and spatial encoding of data associated with the transfer matrix elements are now described in greater detail, in accordance with one or more embodiments of the present disclosure.

In some embodiments, the coding optical elements 114 include a generator 212 in the illumination sub-system 106 and an analyzer 214 in the imaging sub-system 110, where the generator 212 and the analyzer 214 are formed from polarization-manipulating optical elements suitable for coding of input and output Stokes vectors in spatial frequency channels in Fourier space (e.g., spatial frequency space). In this configuration, transfer matrix elements (or combinations thereof) associated with the sample 108 may be deduced from these channels after inverse Fourier transform or other suitable spatial-frequency analysis technique.

The generator 212 and the analyzer 214 may include any components or combinations of components suitable for coding of input and output Stokes vectors in spatial frequency channels in Fourier space. For example, generator 212 and/or the analyzer 214 may be formed from polarization-manipulation components such as, but not limited to, waveplates, BSPs, or BSAs.

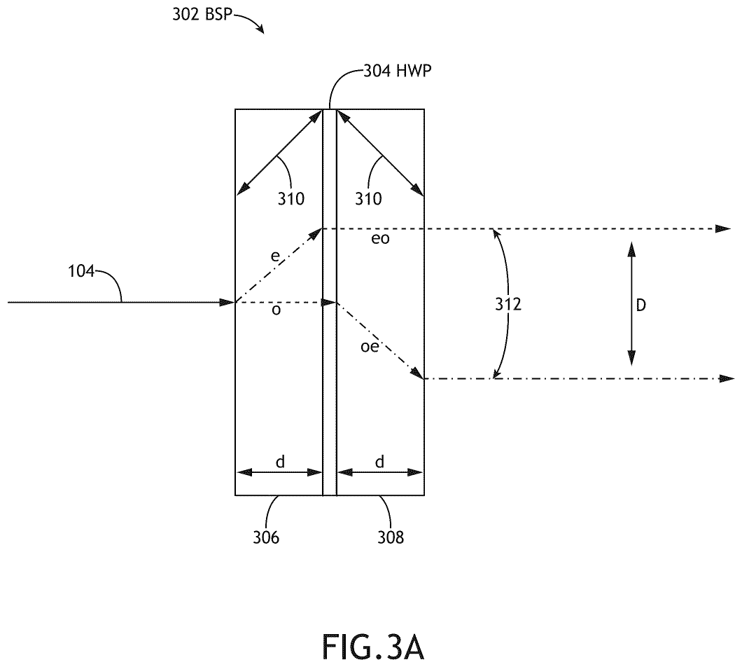

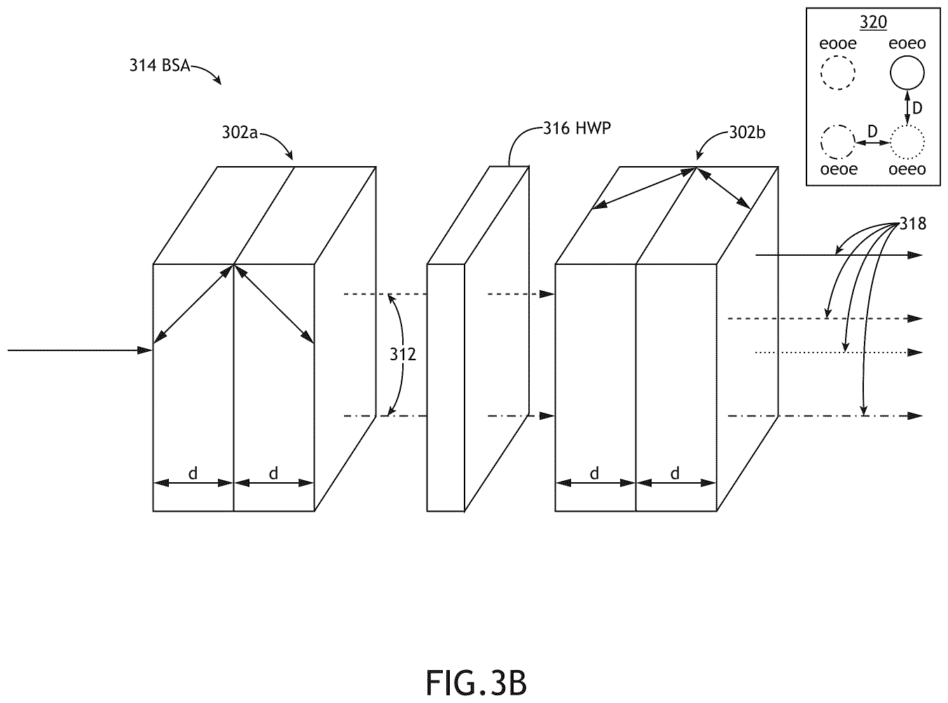

FIG. 3A illustrates a schematic view of a BSP 302, in accordance with one or more embodiments of the present disclosure.

In some embodiments, a BSP 302 includes a half-wave plate (HWP) 304 located between a first shearing plate 306 and a second shearing plate 308. For example, the first shearing plate 306 and the second shearing plate 308 may be formed as birefringent plates with optical axes 310 rotated with respect to each other to provide two spatially-separated beams 312. As an illustration FIG. 3A depicts a non-limiting configuration in which the optical axis of the first shearing plate 306 is oriented at 45-degrees relative to an incidence angle of the frequency combs 104 and 90-degrees with respect to the optical axis of the second shearing plate 308 in a common plane. Further, the HWP 304 is oriented at a 45-degree angle to the polarization of the frequency combs 104 to provide 90-degree polarization rotation between the first shearing plate 306 and the second shearing plate 308. In this configuration, the beam shearing distance D is:

$$D = 2 d \frac{{n}_{o}^{2} - {n}_{e}^{2}}{{n}_{o}^{2} + {n}_{e}^{2}} , \qquad ( 2 )$$

where d is a thickness of the first shearing plate 306 and the second shearing plate 308, nₒ is the ordinary refractive index of the first shearing plate 306 and the second shearing plate 308, and nₑ is the extraordinary refractive index of the first shearing plate 306 and the second shearing plate 308.

It is contemplated herein that the first shearing plate 306 and the second shearing plate 308 may chosen to provide achromatic performance. For example, the chromatic variation in lateral displacement can be reduced by an order of magnitude across a broadband spectrum. Additionally, the shearing distance (D) of the BSP 302 as illustrated in FIG. 3A may be larger than alternative beam shearing plate designs (e.g., may be \sqrt{2} larger than a Savart plate).

FIG. 3B illustrates a schematic view of a BSA 314, in accordance with one or more embodiments of the present disclosure. In some embodiments, a BSA 314 is formed from a HWP 316 located between two BSPs BSP 302 (e.g., two instances of the BSP 302 depicted in FIG. 3A). In particular, FIG. 3B depicts a non-limiting configuration including a first BSP 302a and a second BSP 302b rotated by 90 degrees, where the HWP 316 is oriented with an optical axis at 22.5 degrees with respect to the polarization of the frequency comb sources 102 from the first BSP 302a to provide a 45-degree polarization rotation. In this configuration, the BSA 314 provides four sheared beams 318 separated by the shearing distance D as shown in the inset 320.

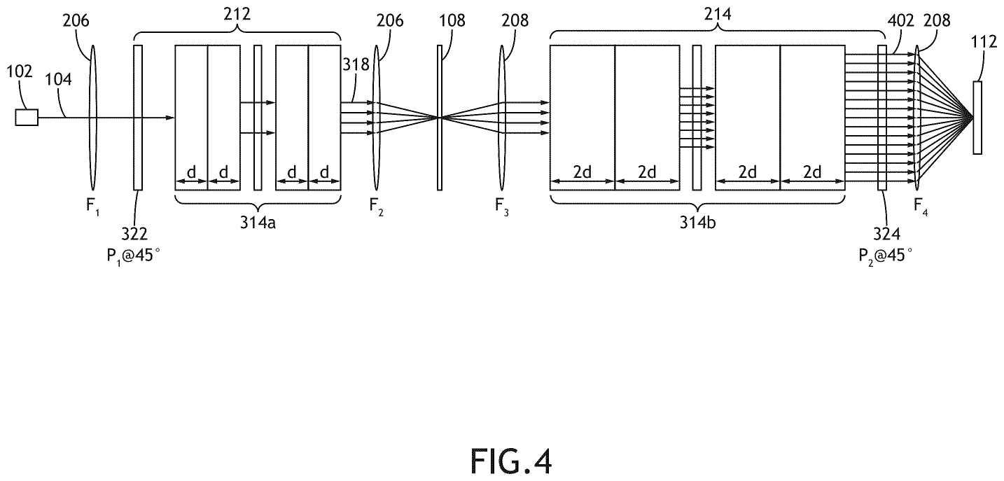

FIG. 4 illustrates an optical chain of the metrology system 100 with a generator 212 prior to the sample 108 and an analyzer 214 after the sample 108, where both the generator 212 and the analyzer 214 are formed with a HWP 316 as depicted in FIG. 3B, in accordance with one or more embodiments of the present disclosure. In particular, FIG. 4 depicts a configuration in which the generator 212 includes a polarizer 322 prior to a BSA 314a and oriented at 45-degrees with respect to a shearing direction of the first BSP 302 in the BSA 314a (e.g., configured to provide that the four sheared beams 318 from the BSA 314a have equal intensity). Additionally, the analyzer 214 includes a polarizer 324 after the second BSA 314b also rotated at 45 degrees.

In this configuration, the analyzer 214 generates four sheared beams 318 that are focused to a common spot on the sample 108 with the illumination lenses 206 (e.g., F2 in FIG. 4) and then diverge after interacting with the sample, where they are collimated by the collection lenses 208 and directed to the BSA 314b. It is noted that although FIG. 4 depicts the sheared beams 318 as propagating through the sample 108, this is merely illustrative. The sheared beams 318 may be reflected by the sample 108 as shown in FIG. 2.

The analyzer 214 may then shear each of the sheared beams 318 into four additional beams, which results in sixteen sheared beams 402. To avoid overlap of the sheared beams 402, the thickness of the BSPs 302 in the analyzer 214 may be different (e.g., thicker) than the BSPs 302 in the generator 212. For example, FIG. 4 depicts a configuration in which the BSPs 302 in the analyzer 214 include are twice as thick (e.g., include birefringent plates that are twice as thick) as the BSPs 302 in the generator 212. In this configuration, the sixteen sheared beams 402 form a uniform grid emanating from the analyzer 214.

The collection lenses 208 (e.g., F4 in FIG. 4) may then refocus the sheared beams 402 onto the detector 112. As described previously herein, imaging sub-system 110 may image the sample 108 onto the detector 112 with the various sheared beams 402, where an image generated by the detector 112 corresponds to an interferogram associated with the combination of the sheared beams 402. Further, the collection lenses 208 in the imaging sub-system 110 may form a spatial frequency plane located at a focal distance away from the two collection lenses 208. For example, the collection lenses 208 may form a 4-F imaging system in which the sample 108 is located a focal length away from the first collection lens 208 (F1), the detector 112 is located a focal length away from the second collection lens 208 (F2), and a spatial frequency plane is between the two collection lenses 208 and a focal length away from each. In this configuration, each of the sheared beams 402 is located at a different location in the spatial frequency plane and may thus correspond to a spatial frequency channel in an image of the sample 108 generated by the detector 112.

In this configuration, the input Stokes vector associated with the frequency combs 104 prior to the generator 212 may be written as

$${S}_{in} ( x , y ) - {( \frac{{S}_{0 , in} ( x , y )}{2} ) [ 1 , 0 , 1 , 0 ]}^{T} , {S}_{0 , in} \qquad ( 3 )$$

where S_{0,in} is the total incident power. The output Stokes vector of the distribution of light at the detector 112 after the analyzer 214 may then be written as:

$${S}_{out} ( x , y ) = {P}_{2} ( 45 ° ) {BSP}_{4} {HWP}_{2} ( 22.5 ° ) {BSP}_{3} MM ( x , y ) {BSP}_{2} {HWP}_{1} ( 22.5 ° ) {BSP}_{1} {P}_{1} ( 45 ° ) {S}_{in} ( x , y ) \qquad ( 4 )$$

where BSP₁ and BSP₂ are birefringent plates in the first BSP 302a, BSP₃ and BSP₄ are birefringent plates in the second BSP 302b, P₁ is the first polarizer 322, P₂ is the second polarizer 324, and MM(x,y) represents Mueller matrix data (e.g., transfer matrix data) associated with the sample 108.

It is contemplated herein that the various sheared beams 402 have different polarization states and that each may provide information associated with one or more Mueller matrix elements associated with the sample 108. For instance, each of the various sheared beams 402 may be analogous to polarization configurations that may be generated by a traditional single-beam ellipsometer. However, the systems and methods disclosed herein provide such configurations simultaneously instead of sequentially.

It is further contemplated herein that the Mueller matrix elements associated with the sample 108 may be encoded into various spatial frequency channels within an image of the sample 108 generated using the metrology system 100. For example, an image generated by the detector 112 in FIG. 4 may include 33 channels in the spatial frequency domain (e.g., the Fourier domain), where each channel corresponds to a sum of certain Mueller matrix elements. Mueller matrix element data in any particular channel may then be recovered using spatial frequency filtering to isolate the spatial frequencies within the image associated with the location of the particular one of the channels in the spatial frequency plane. For example, the processors 118 of the controller 116 may perform a spatial Fourier transform of an image from the detector 112, isolate the spatial frequencies associated with the particular one of the channels, and perform a second spatial Fourier transform of the resulting signal to generate a channel image. In this way, the spatially-filtered channel image may provide a spatially-resolved ellipsometry measurement for the particular polarization configuration, which may in turn provide spatially-resolved data associated with the associated Mueller matrix data (e.g., transfer matrix data).

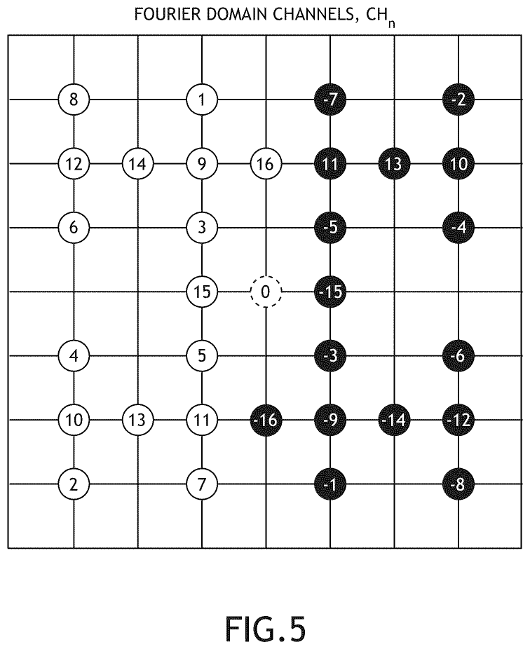

FIG. 5 illustrates a simplified diagram of various channels within a spatial frequency plane of an image, in accordance with one or more embodiments of the present disclosure. Table 1 depicts the Mueller matrix data in each of the channels, in accordance with one or more embodiments of the present disclosure.

| CHₙ = Sₙx(S_{0, in}(x, y)/16) | Sₙ, Sum of Mueller Matrix elements |
|---|---|
| 0 | 16m₀₀ |
| ±1 | 2m₁₂ − m₂₂ − m₃₃ ± |
| | 2m₁₃ ∓ im₂₃ ± im₃₂ |
| ±2 | m₂₂ − m₃₃ ∓ im₂₃ ∓ im₃₂ |
| ±3 | −4m₀₂ − 2m₁₂ + m₂₂ − m₃₃ ∓ |
| | 4im₀₃ ± 2im₁₃ ∓ im₂₃ ∓ im₃₂ |
| ±4 | −m₂₂ − m₃₃ ∓ im₂₃ ± im₃₂ |
| ±5 | 4m₀₂ + 2m₁₂ + m₂₂ + m₃₃ ∓ |
| | 4im₀₃ ± 2im₁₃ ± im₂₃ ∓ im₃₂ |
| ±6 | −m₂₂ + m₃₃ ± im₂₃ ± im₃₂ |
| ±7 | −2m₁₂ − m₂₂ + m₃₃ ± |
| | 2im₁₃ ± im₂₃ ± im₃₂ |
| ±8 | m₂₂ + m₃₃ ± im₂₃ ∓ im₃₂ |
| ±9 | 4m₁₁+ 2m₂₁ ∓ 2im₃₁ |
| ±10 | −2m₂₁ ± 2im₃₁ |
| ±11 | 4m₁₁ − 2m₂₁ ± 2im₃₁ |
| ±12 | 2m₂₁ ∓ 2im₃₁ |
| ±13 | 4m₂₀ ∓ 4im₃₀ |
| ±14 | −4m₂₀ ± 4im₃₀ |
| ±15 | −8m₀₁ |
| ±16 | −8m₁₀ |

Table 2 depicts the recovery of various Mueller matrix elements (mmᵢⱼ) based on one or more channel images.

Recover Mueller Matrix Elements mᵢⱼ from calibrated
Fourier domain channels, cₙ

| Element | |
|---|---|
| m₀₀ | $\frac{\vert {I}_{r 0} \vert}{\vert {I}_{s 0} \vert}$ |
| m₀₁ | −2Re{c₁₅} |
| m₀₂ | −4Re{c₂ + c₇ − c₃ − c₆} |
| m₀₃ | 4lm{c₂ + c₇ − c₃ − c₆} |
| m₁₀ | −2Re{c₁₆} |
| m₁₁ | 4Re{c₁₁ + c₁₂} |
| m₁₂ | 8Re{c₇ − c₆} |
| m₁₃ | 8lm{c₇ − c₆} |
| m₂₀ | −2Re{c₁₃ − c₁₄} |
| m₂₁ | −4Re{c₉ − c₁₁} |
| m₂₂ | 8Re{c₈ − c₆} |
| m₂₃ | −8lm{c₈ + c₆} |
| m₃₀ | 2lm{c₁₄ − c₁₃} |
| m₃₁ | −4lm{c₁₁ − c₉} |
| m₃₂ | 8lm{c₆ − c₈} |
| m₃₃ | −8Re{c₈ + c₆} |

In Table 2,

$${c}_{n} = {S}_{rn} \cdot ( \frac{{I}_{sn}}{{I}_{rn}} ) \cdot ( \frac{\vert {I}_{r 0} \vert}{\vert {I}_{s 0} \vert} ) ,$$

Iₛₙ and Iᵣₙ correspond to the sample's and reference's CHₙ, and Sᵣₙ corresponds to the sum of Mueller matrix elements in the nth channel of the reference light.

Taking FIG. 5 and Tables 1 and 2 together, a spatially-resolved measurement of any particular Mueller matrix element associated with the sample 108 may be generated by capturing an image of the sample 108 with the detector 112, generating one or more channel images based on spatial frequency filtering of the image from the detector 112, and recovering a spatially-resolved map of the values of the particular Mueller matrix element based on a combination of channel images (e.g., as depicted in Table 2).

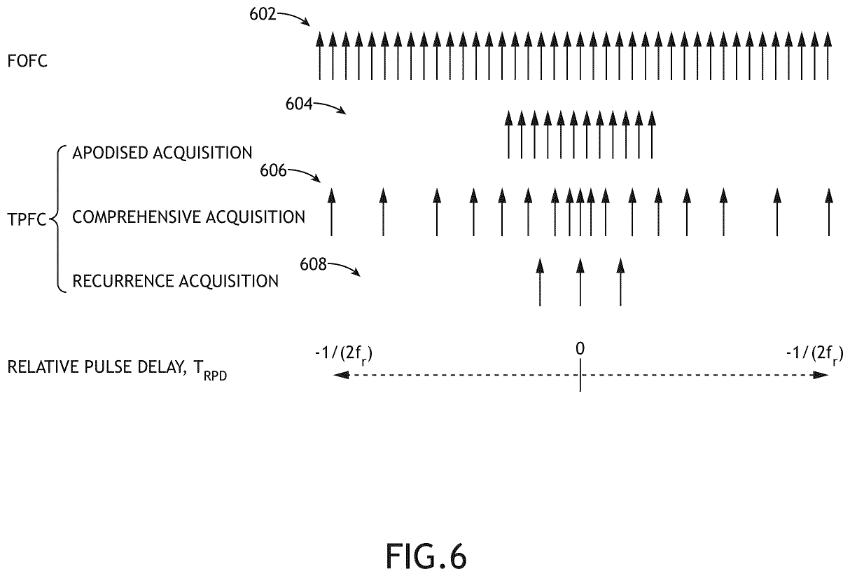

Referring now to FIG. 6, the above steps may be repeated for a series of images (e.g., a temporal series of images generated at different times) to generate spectrally-resolved Mueller matrix data. FIG. 6 illustrates different sampling regimes using dual frequency combs 104, in accordance with one or more embodiments of the present disclosure. In some embodiments, the frequency combs 104 are fixed-offset frequency combs (FOFC), which relies on control of the relative comb repetition rates and their difference (Δf) to sample at continuous, evenly spaced increments of ΔT_{RPD} over relative pulse delays (T_{RPD}) from −1/(2 fᵣ) to +1/(2fᵣ), where fᵣ is the frequency of a reference frequency comb 104 (e.g., illustrated in inset 602). The resulting heterodyne RF signal is broadband and can be mapped to the frequency-domain spectral response. In this configuration, there are tradeoffs between measurement speed, sensitivity, resolution, and the like. In some embodiments, the frequency combs 104 are Time Programmable Frequency Combs (TPFC). The TPFC approach goes beyond the optically self-referenced FOFC, replacing it with a digitally dynamic control of the relative comb pulse delays (T_{RPD}). In this configuration with the ability to control the relative pulse timing, one can program arbitrary sampling patterns in region of interest (e.g., apodised acquisition as illustrated in inset 604), in scaled sample reduction (e.g., compressive acquisition as illustrated in inset 606), or at a fixed time offset (e.g., recurrence acquisition as illustrated in inset 608).

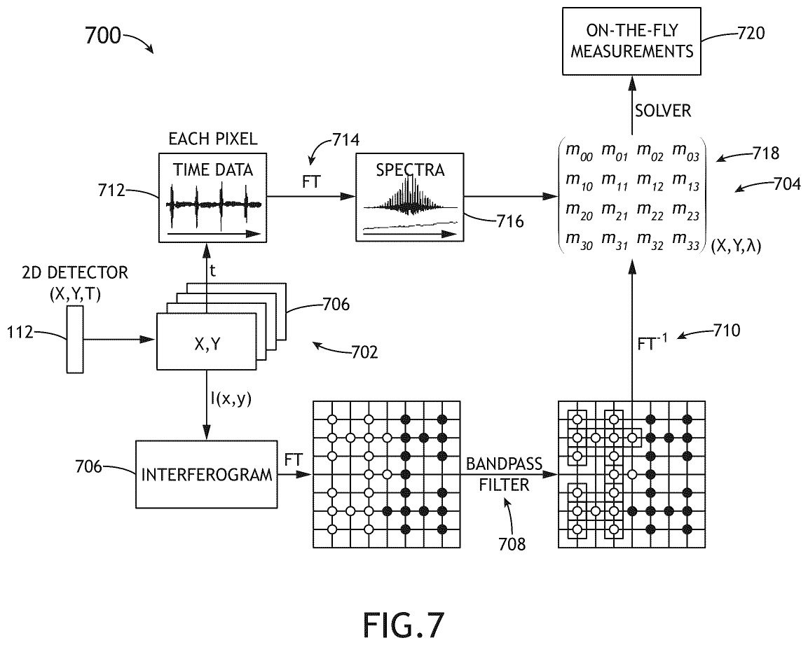

FIG. 7 illustrates a series of steps for generating spatially and spectrally resolved Mueller matrix data, in accordance with one or more embodiments of the present disclosure.

In some embodiments, the method 700 includes a step 702 of generating one or more channel images based on a spatial frequency filtering technique applied to an image of the sample 108. In some embodiments, the method 700 includes a step 704 of generate one or more Mueller matrix element datasets (e.g., transfer matrix element datasets) based on the one or more channel images, where the Mueller matrix dataset (e.g., the transfer matrix dataset) includes the one or more Mueller Matrix element datasets.

For example, FIG. 7 depicts performing a spatial Fourier transform of an image 706 (e.g., an interferogram image) generated by the detector 112, using a bandpass filter operation (708) to isolate data in one or more spatial frequency channels, performing an additional spatial Fourier transform (710) to generate a channel image (not explicitly shown in FIG. 7). As described with respect to FIGS. 5, Table 1 and Table 2 above, spectrally-resolved Mueller matrix element data (e.g., Mueller matrix element images) may be generated based on combinations of one or more channel images. This process may be repeated to generate spatially-resolved Mueller matrix data for any number of Mueller matrix elements. This process may further be repeated on a sequence of images from the detector 112 to generate a sequence of Mueller matrix element images.

In some embodiments, the method 700 includes a step 712 of extracting, for at least some pixels in the sequence of images, spectrally-resolved Mueller matrix element data using a spectral frequency analysis technique. For example, FIG. 7 depicts performing a temporal frequency analysis (e.g., a temporal Fourier transform) on temporal data associated with a common pixel (714) in the sequence of images to generate amplitude and phase spectral data (716). In particular, the temporal Fourier transform of the RF beating voltage signal at frequency comb repetition rate fᵣ leads to Amplitude and Phase spectra at the pixel, which may provide spectrally-resolved data. When combined with the Mueller matrix element images, a full set of spectrally and spatially resolved Mueller matrix data 718 may be generated.

The Mueller matrix data 718 may then be used to generate one or more measurements 720 of the sample 108 (e.g., in step 128 of the method 122 depicted in FIG. 1B). For example, FIG. 7 depicts a map (e.g., an on-the-fly measurement map) associated with spatially-resolved measurement (e.g., overlay, CD, or the like) generated based on the Mueller matrix data 718.

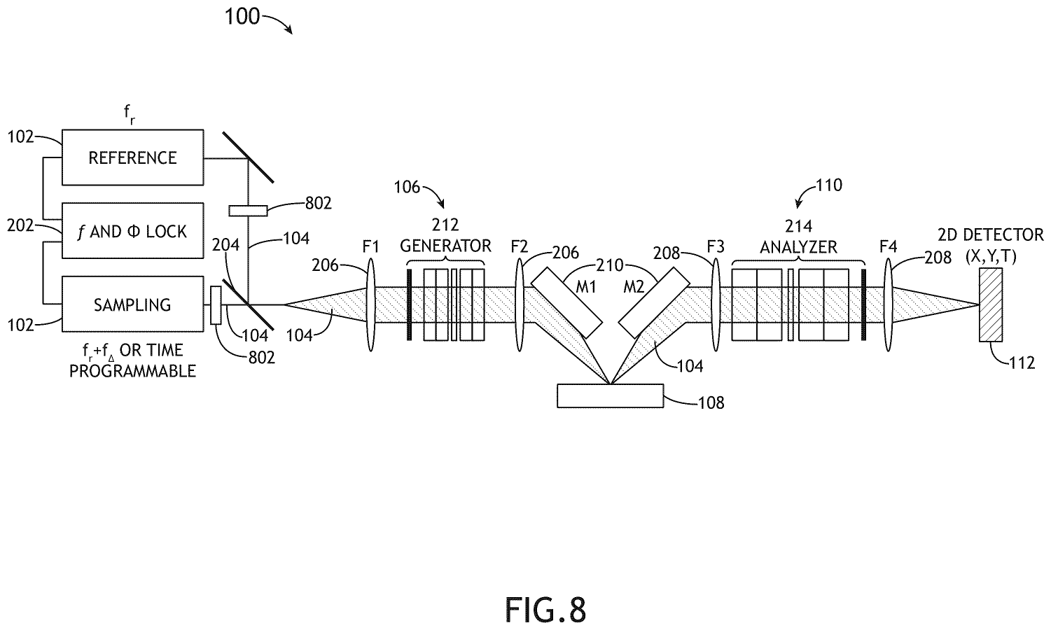

Referring now to FIGS. 8-16, FIGS. 8-16 depict non-limiting variations of the metrology system 100, in accordance with one or more embodiments of the present disclosure.

FIG. 8 illustrates a schematic view of a metrology system 100, in accordance with one or more embodiments of the present disclosure. FIG. 8 is substantially similar to FIG. 2 such that the descriptions of FIG. 2 above may be extended to FIG. 8, except that FIG. 8 further includes spectral shifters 802 to shift and/or broaden the spectra of at least one of the frequency combs 104. As an illustration, one or both of the frequency combs 104 generated by the frequency comb sources 102 may have wavelengths in the visible or near infrared wavelengths, where the spectral shifters 802 may shift the spectra of at least one of the frequency combs 104 to higher wavelengths (e.g., 2-12 μm) and/or lower wavelengths (e.g., wavelengths in visible or ultraviolet spectral ranges). In this way, the spectral range of the Mueller matrix data may be extended.

The spectral shifters 802 may include any type of element suitable for shifting and/or broadening the spectra of at least one of the frequency combs 104. For example, a spectral shifter 802 may include, but is not limited to, a non-linear crystal, a photonic crystal fiber, or the like.

In some embodiments, electro-optic sampling (EOS) may be used to shift the detection wavelength relative to the wavelengths of the frequency combs 104. For example, it may be the case that a detector suitable for mid-infrared wavelengths may have various drawbacks relative to a detector suitable for mid-infrared, near-infrared or visible wavelengths such as, but not limited to, relatively slow readout times, high noise, low resolution, high-cost, or a requirement for cryogenic cooling. Accordingly, EOS sampling (e.g., with an EOS detector 112) may allow measurements in a desired wavelength range.

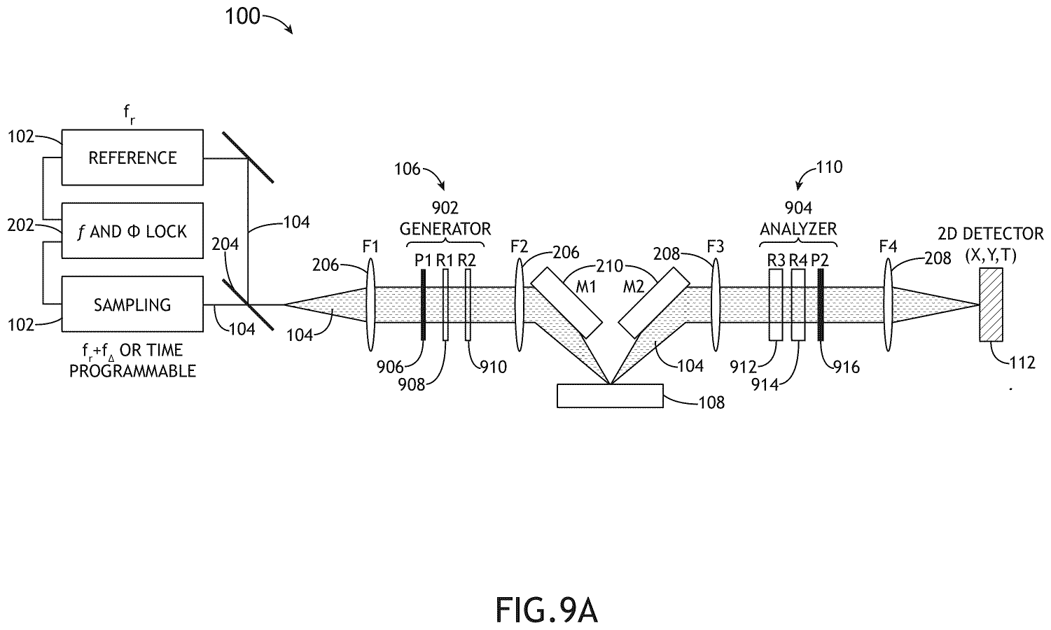

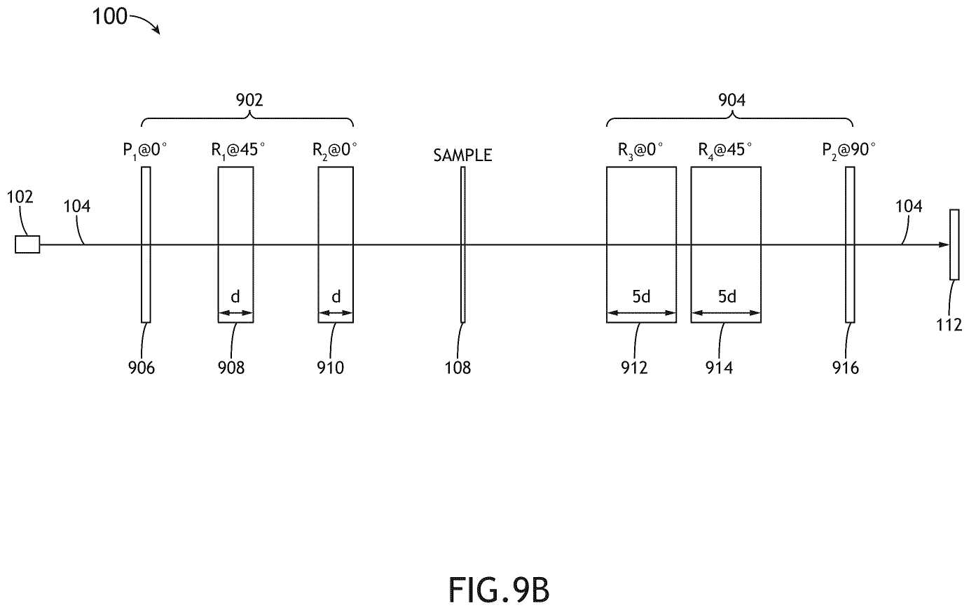

FIGS. 9A-12 depict Mueller matrix data (e.g., transfer matrix data) generated based on spectral frequency coding. FIG. 9A illustrates a schematic view of a metrology system 100, in accordance with one or more embodiments of the present disclosure.

In some embodiments, the coding optical elements 114 include a series of spectrally-dependent phase retarders. For example, FIG. 9A depicts a configuration in which the coding optical elements 114 include a generator 902 in the illumination sub-system 106 and an analyzer 904 in the imaging sub-system 110, where the generator 902 and the analyzer 904 include spectrally-dependent phase retarders with different thicknesses and thus different retardation values.

FIG. 9B illustrates an optical chain of the metrology system 100 in FIG. 9A, in accordance with one or more embodiments of the present disclosure. In this non-limiting configuration, the generator 902 includes a first polarizer 906 at 0-degree orientation followed by a first retarder 908 with phase retardation o (e.g., thickness d) at a 45-degree rotation and a second retarder 910 with the same phase retardation ¢ at a 0-degree orientation. The analyzer 904 then includes a third retarder 912 with five times the phase retardation 5ϕ (e.g., thickness 5d) at 0-degree orientation, a fourth retarder 914 with the same phase retardation 5ϕ at 45-degree orientation, and a second polarizer 916 at 90-degree orientation. In this case, the combination of (1,1,5,5) cascaded phase retarders results in 13 channels of spectral frequency modulation. It is contemplated herein that any the number of channels may be determined by the selection of retarder thicknesses. For example, the maximum number of independent modulation channels is 49 if retardance of every retarder is different. Further, the higher the number of channels, the lower the spectral resolving power. It is further contemplated herein that the selection of the third and fourth retarders 912,914 having five times the thickness of the first and second retarders 908,910 may beneficially prevent an overlap of harmonics. However, any retarder thicknesses and any number of channels is within the spirit and scope of the present disclosure.

In this configuration, the output Stokes vector may be written as:

$${S}_{out} = {P}_{2} ( 90 ° ) {R}_{4} ( 5 ϕ , 45 ° ) {R}_{3} ( 5 ϕ , 0 ° ) MM ( x , y ) {R}_{2} ( ϕ , 0 ° ) {R}_{1} ( ϕ , 45 ° ) {P}_{1} ( 0 ° ) {S}_{in} \qquad ( 5 )$$

$$where ϕ = 2 πΔ n ( λ ) d / λ = {ϕ}_{0} + {f}_{0} / λ .$$

The recovery of Mueller matrix elements based on different modulation channels is listed in Table 3 for this configuration, in accordance with one or more embodiments of the present disclosure.

TABLE 3

| Fₙ | Real Part Magnitude (x64) | Imaginary Part Magnitude (x64) |
|---|---|---|
| 0 | 16m₀₀ + 8m₀₂ − 8m₂₀ − 4m₂₂ | 0 |
| f₀ | 8m₀₁ − 4m₂₁ | 0 |
| 2f₀ | −4m₀₂ + 2m₂₂ | −4m₀₃ + 2m₂₃ |
| 3f₀ | 2m₁₂ | −2m₁₃ |
| 4f₀ | −4m₁₁ | 0 |
| 5f₀ | −8m₁₀ − 4m₁₂ | 0 |
| 6f₀ | −4m₁₁ | 0 |
| 7f₀ | 2m₁₂ | 2m₁₃ |
| 8f₀ | −m₂₂ + m₃₃ | m₂₃ + m₃₂ |
| 9f₀ | 2m₂₁ | −2m₃₁ |
| 10f₀ | 4m₂₀ + 2m₂₂ | −4m₃₀ − 2m₃₂ |
| 11f₀ | 2m₂₁ | −2m₃₁ |
| 12f₀ | −m₂₂ − m₃₃ | −m₂₃ + m₃₂ |

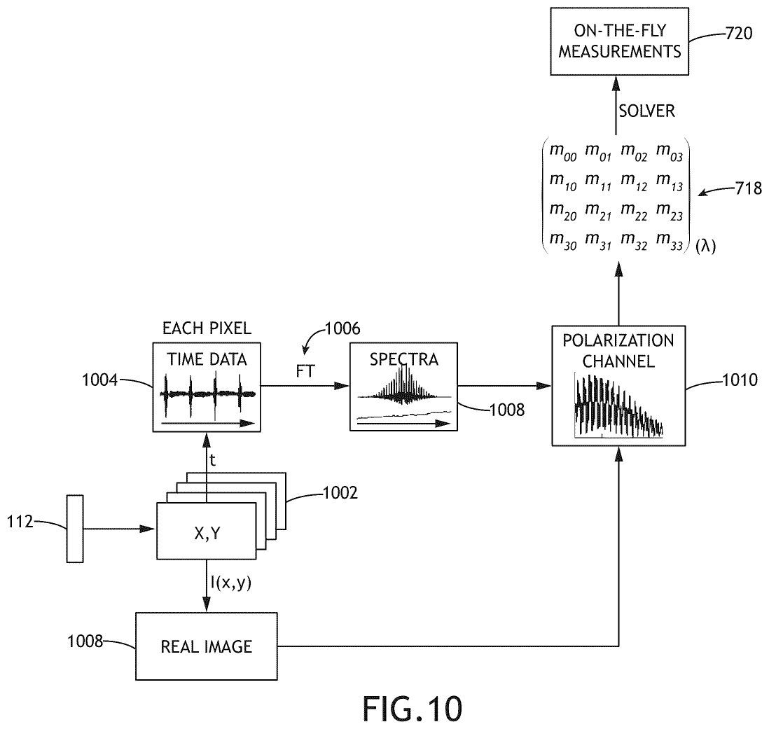

FIG. 10 illustrates a series of steps for generating spatially and spectrally resolved Mueller matrix data based on spectral coding, in accordance with one or more embodiments of the present disclosure. In FIG. 10, images generated by the detector 112 correspond to real images 1002 of the sample 108 (e.g., as compared to an interferogram based on interference of sheared beams 402 as depicted in FIG. 4). Additionally, time data associated with each pixel is extracted (1004) and a temporal frequency analysis (e.g., a temporal Fourier transform) is performed on temporal data associated with a common pixel (1006) in the sequence of images to generate amplitude and phase spectral data (1008). Further, various polarization channels (1010) may be analyzed to generate the Mueller matrix data 718 (e.g., transfer matrix data) for each pixel. The Mueller matrix data 718 may then be used as the basis for the generation of measurement data (e.g., metrology data, inspection data, or the like) as depicted in step 128 of method 122.

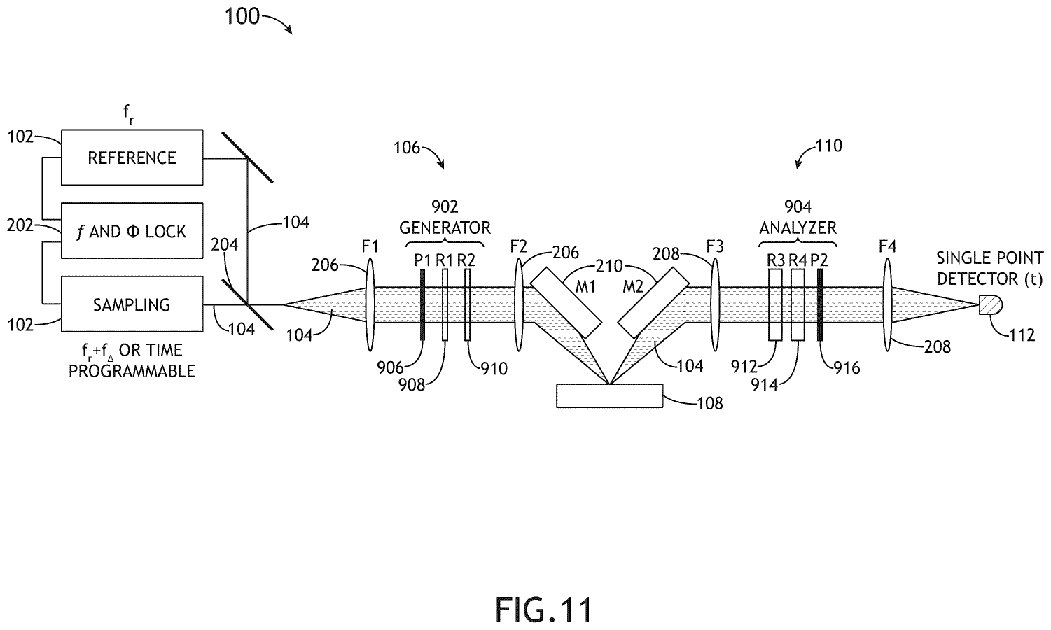

FIG. 11 illustrates a schematic view of a metrology system 100, in accordance with one or more embodiments of the present disclosure. FIG. 11 is substantially similar to FIG. 9A, except that the detector 112 is a single-pixel sensor (e.g., a photodetector). Such a configuration may be suitable for measurements of a single spot on the sample 108 (e.g., the Mueller matrix data 718 is not spatially resolved).

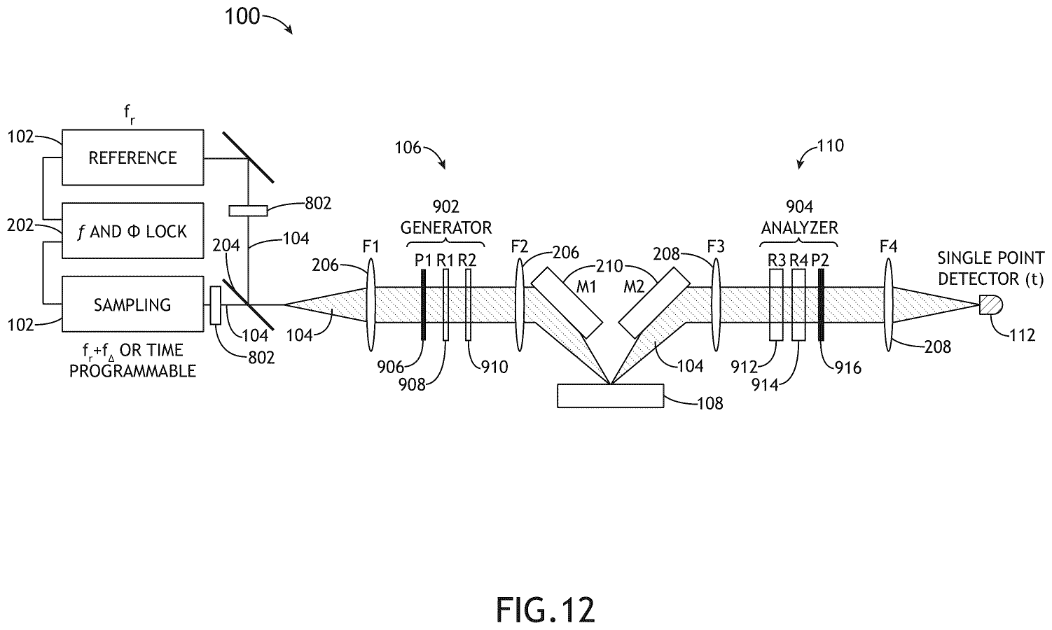

FIG. 12 illustrates a schematic view of a metrology system 100, in accordance with one or more embodiments of the present disclosure. FIG. 12 is substantially similar to FIG. 11, with the addition of spectral shifters 802, which may modify the spectral content of at least one of the frequency combs 104 in a manner similar to the configuration depicted in FIG. 8. In this way, the descriptions of FIG. 8 may be extended to FIG. 12. For example, EOS detection may be utilized in FIG. 12 such that the detector 112 in FIG. 12 may be selected to operate at a desired wavelength range different than that provided by the frequency combs 104.

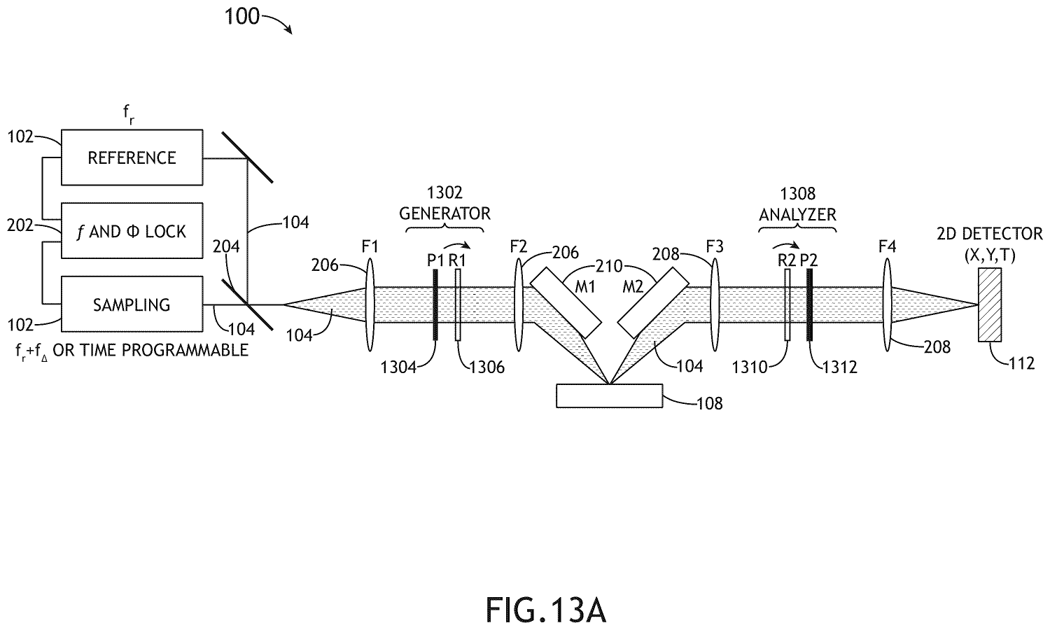

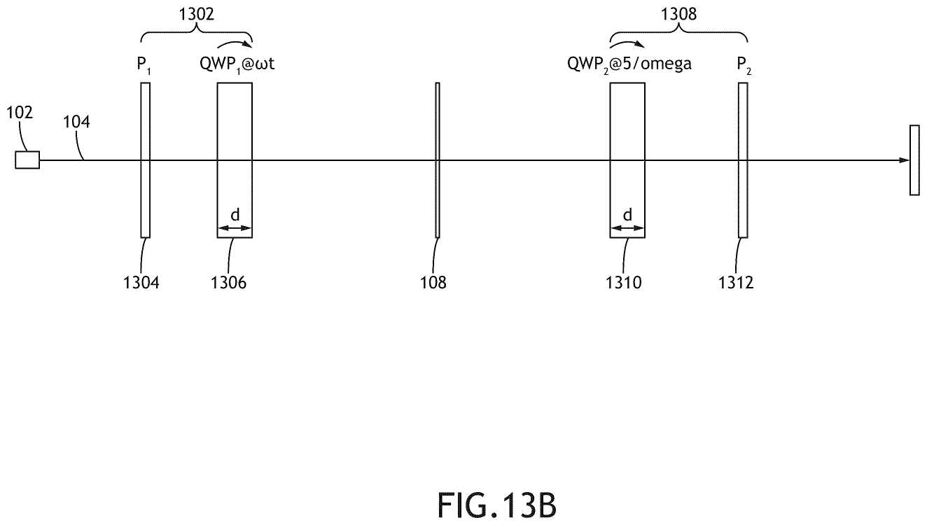

FIGS. 13A-16 depict Mueller matrix data generating based on temporal polarization coding. FIG. 13A illustrates a schematic view of a metrology system 100, in accordance with one or more embodiments of the present disclosure.

In some embodiments, the coding optical elements 114 include one or more rotating elements in the illumination sub-system 106 and the imaging sub-system 110 to provide temporal coding of Mueller matrix data (e.g., transfer matrix data). For example, the coding optical elements 114 may include rotating quarter waveplates and/or polarizers.

As an illustration, FIG. 13B illustrates an optical chain of the metrology system 100 depicted in FIG. 13A, in accordance with one or more embodiments of the present disclosure. In the particular configuration in FIG. 13B, a generator 1302 in the illumination sub-system 106 includes a first polarizer 1304 and a first rotating quarter waveplate 1306 with a thickness d, which may rotate at a first angular frequency ω. An analyzer 1308 in the imaging sub-system 110 may then include a second rotating quarter waveplate 1310 and a second polarizer 1312. This second rotating quarter waveplate may have the same thickness d, but may rotate at a different angular frequency (e.g., 5ω) than the first rotating quarter waveplate 1306. In this configuration, the output Stokes vector may be written as:

$${S}_{out} = {P}_{2} {QWP}_{2} ( 5 ω t ) MM ( x , y ) {QWP}_{1} ( ω t ) {P}_{1} {S}_{in} \qquad ( 6 )$$

Further, this configuration may provide that Mueller matrix elements are encoded in 25 channels of Fourier expansion coefficients associated with an intensity signal measured by the detector 112. The recovery of the Mueller matrix elements encoded in Fourier expansion coefficients of an intensity signal measured by the detector 112 is described in Table 4. Again, it is contemplated herein that any combination of angular frequencies may be utilized and that selections of different angular frequencies may provide different number of channels. However, some configurations may beneficially prevent harmonic overlaps and/or may provide relatively more efficient coding.

TABLE 4

| | | Real Part | Imaginary Part |
|---|---|---|---|
| Real Part | Imaginary Part | Magnitude (x64) | Magnitude (x64) |
| ${a}_{0} = {m}_{00} + \frac{{m}_{01}}{2} + \frac{{m}_{10}}{2} + \frac{{m}_{11}}{4}$ | | | |
| a₁ = 0 | ${b}_{1} = {m}_{03} + \frac{{m}_{13}}{2}$ | ${a}_{7} = \frac{{m}_{32}}{4}$ | ${b}_{7} = \frac{- {m}_{31}}{4}$ |
| ${a}_{2} = \frac{{m}_{01}}{2} + \frac{{m}_{11}}{4}$ | ${b}_{2} = \frac{{m}_{02}}{2} + \frac{{m}_{12}}{4}$ | ${a}_{8} = \frac{{m}_{11}}{8} + \frac{{m}_{22}}{8}$ | ${b}_{8} = \frac{- {m}_{12}}{8} + \frac{{m}_{21}}{8}$ |
| ${a}_{3} = \frac{{m}_{32}}{4}$ | ${b}_{3} = \frac{- {m}_{31}}{4}$ | ${a}_{9} = \frac{{m}_{23}}{4}$ | ${b}_{9} = \frac{- {m}_{13}}{4}$ |
| ${a}_{4} = \frac{{m}_{33}}{2}$ | b₄ = 0 | ${a}_{10} = \frac{{m}_{10}}{4} + \frac{{m}_{11}}{4}$ | ${b}_{10} = \frac{{m}_{20}}{2} + \frac{{m}_{21}}{4}$ |
| a₅ = 0 | ${b}_{5} = - {m}_{30} - \frac{{m}_{31}}{2}$ | ${a}_{11} = \frac{{m}_{23}}{4}$ | ${b}_{11} = \frac{{m}_{13}}{4}$ |
| ${a}_{6} = \frac{{m}_{33}}{2}$ | b₆ = 0 | ${a}_{12} = \frac{{m}_{11}}{8} - \frac{{m}_{22}}{8}$ | ${b}_{12} = \frac{{m}_{12}}{8} + \frac{{m}_{21}}{8}$ |

It is to be understood, however, that the depiction of rotating quarter waveplates in FIG. 13B is merely for illustrative purposes and should not be interpreted as limiting the scope of the present disclosure. Rather, the coding optical elements 114 may include any type or combination of rotating elements suitable for coding transfer matrix data into images generated by the detector 112.

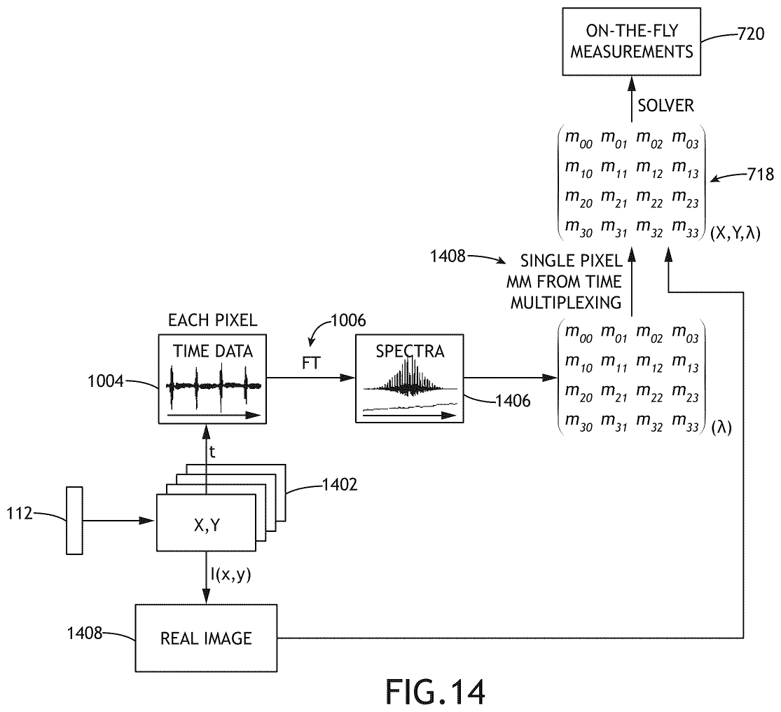

FIG. 14 illustrates a series of steps for generating spatially and spectrally resolved Mueller matrix data based on temporal polarization coding, in accordance with one or more embodiments of the present disclosure. In FIG. 14, images generated by the detector 112 correspond to real images 1402 of the sample 108 in a manner similar to FIG. 10. Additionally, time data associated with each pixel is extracted (1404) and a temporal frequency analysis (e.g., a temporal Fourier transform) is performed on temporal data associated with a common pixel in the sequence of images to generate amplitude and phase spectral data (1406). Further, time multiplexing may be applied (1408) to generate the Mueller matrix data 718 (e.g., transfer matrix data) for each pixel. The Mueller matrix data 718 may then be used as the basis for the generation of measurement data (e.g., metrology data, inspection data, or the like) as depicted in step 128 of method 122.

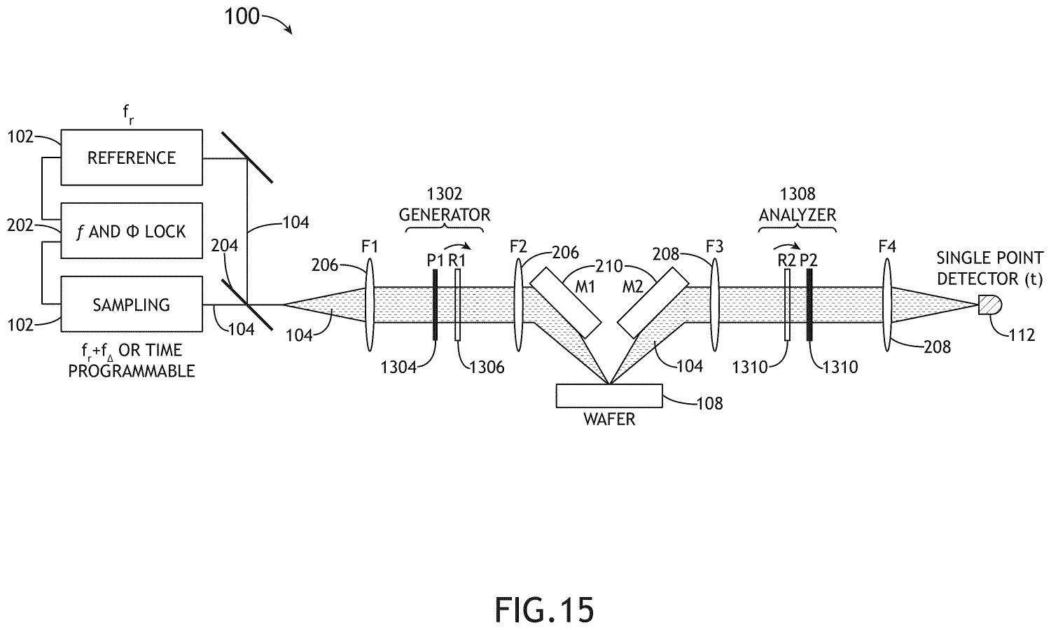

FIG. 15 illustrates a schematic view of a metrology system 100, in accordance with one or more embodiments of the present disclosure. FIG. 15 is substantially similar to FIG. 13A, except that the detector 112 is a single-pixel sensor (e.g., a photodetector). Such a configuration may be suitable for measurements of a single spot on the sample 108 (e.g., the Mueller matrix data 718 is not spatially resolved).

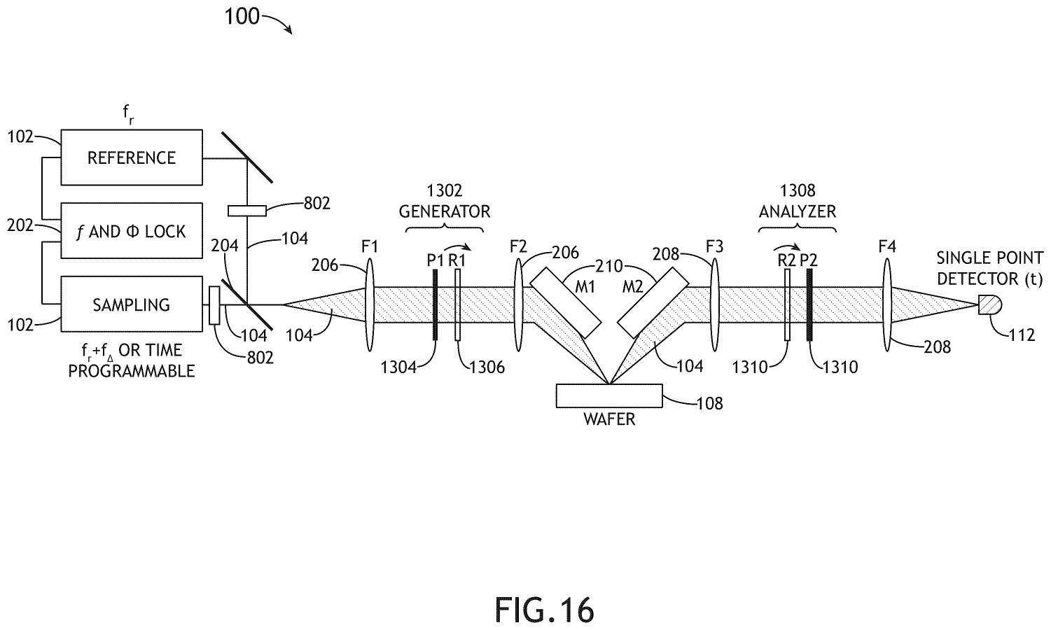

FIG. 16 illustrates a schematic view of a metrology system 100, in accordance with one or more embodiments of the present disclosure. FIG. 16 is substantially similar to FIG. 15, with the addition of spectral shifters 802, which may modify the spectral content of at least one of the frequency combs 104 in a manner similar to the configuration depicted in FIG. 8. In this way, the descriptions of FIG. 8 may be extended to FIG. 16. For example, EOS detection may be utilized in FIG. 16 such that the detector 112 in FIG. 16 may be selected to operate at a desired wavelength range different than that provided by the frequency combs 104.

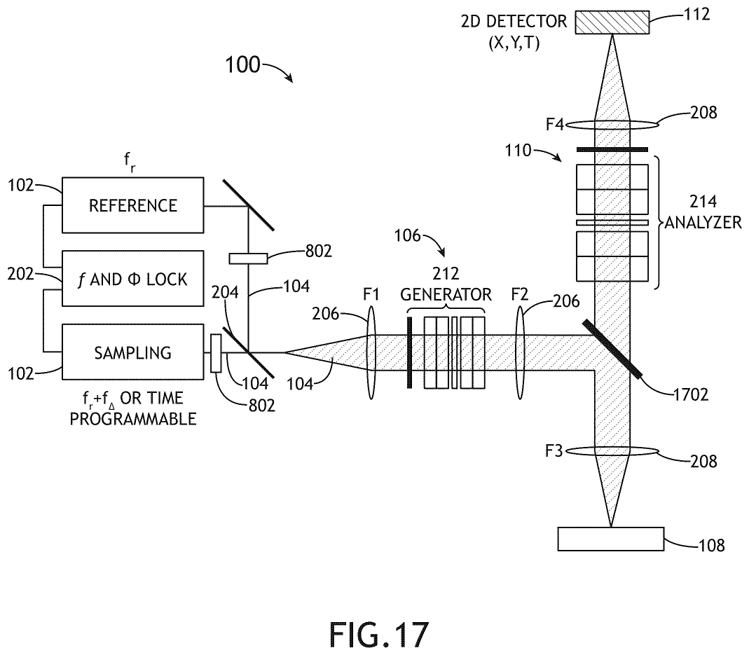

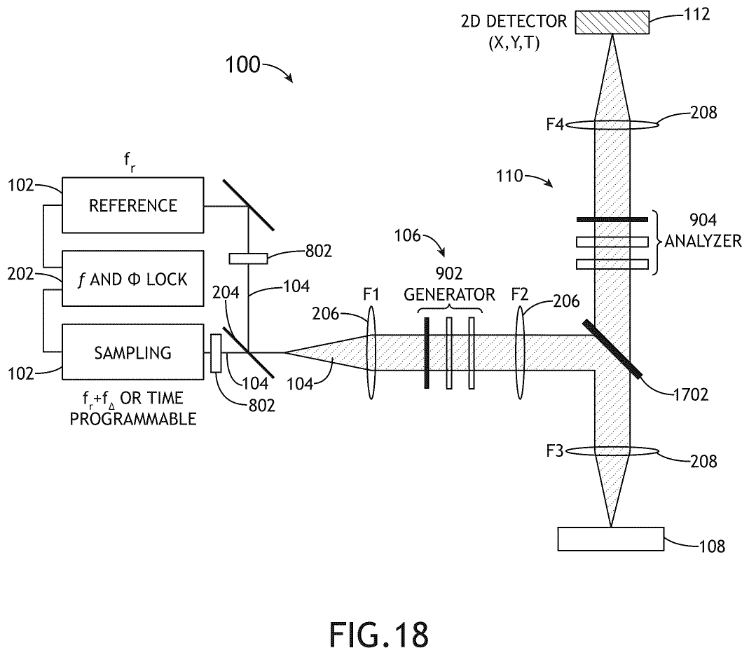

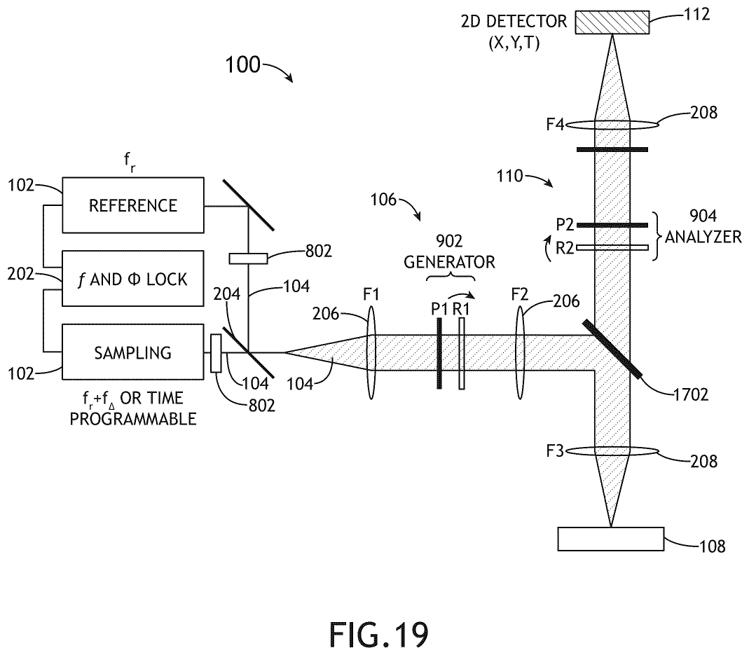

Referring generally to FIGS. 2-16, it is to be understood that FIGS. 2-16 are provided solely for illustrative purposes and should not be interpreted as limiting the scope of the present disclosure. For example, FIGS. 2, 9A, and 13A depict a configuration of the metrology system 100 in which the one or more frequency combs 104 incident on the sample 108 are provided at an oblique incidence angle in a manner similar to conventional ellipsometry systems. However, this is not a requirement. FIGS. 17-19 depict variations of the metrology system 100 providing both illumination and imaging at normal incidence angles. It is contemplated herein that imaging at normal incidence angles may be easier to implement and may in some cases provide fewer aberrations than imaging at oblique angles. FIG. 17 illustrates a schematic view of a variation of the metrology system 100 depicted in FIG. 2, in accordance with one or more embodiments of the present disclosure. FIG. 18 illustrates a schematic view of a variation of the metrology system 100 depicted in FIG. 9A, in accordance with one or more embodiments of the present disclosure. FIG. 19 illustrates a schematic view of a variation of the metrology system 100 depicted in FIG. 13A, in accordance with one or more embodiments of the present disclosure. In FIGS. 17-19, the first collection lens 208 (e.g., F3) may be provided as an objective lens. Further, the metrology system 100 in these embodiments may include a beamsplitter 1702 such that the one or more frequency combs 104 incident on the sample 108 may also be directed through the objective lens. In this configuration, the objective lens may also be a part of the illumination sub-system 106.

Additionally, in FIGS. 17-19, the detector 112 may be a multi-pixel detector or a single-pixel detector. In this way, FIGS. 17-19 may be suitable for providing Mueller matrix data 718 using any of the techniques depicted in FIGS. 2-16.

The herein described subject matter sometimes illustrates different components contained within, or connected with, other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “connected” or “coupled” to each other to achieve the desired functionality, and any two components capable of being so associated can also be viewed as being “couplable” to each other to achieve the desired functionality. Specific examples of couplable include but are not limited to physically interactable and/or physically interacting components and/or wirelessly interactable and/or wirelessly interacting components and/or logically interactable and/or logically interacting components.

It is believed that the present disclosure and many of its attendant advantages will be understood by the foregoing description, and it will be apparent that various changes may be made in the form, construction, and arrangement of the components without departing from the disclosed subject matter or without sacrificing all of its material advantages. The form described is merely explanatory, and it is the intention of the following claims to encompass and include such changes. Furthermore, it is to be understood that the invention is defined by the appended claims.

What is claimed:

1. A measurement system comprising:
a first frequency comb source configured to generate a first frequency comb;
a second frequency comb source configured to generate a second frequency comb with a different repetition rate than the first frequency comb, wherein the second frequency comb source is at least one of frequency or phase-locked to the first frequency comb source;
an illumination sub-system including one or more illumination lenses to direct an illumination beam including at least one of the first frequency comb or the second frequency comb to a sample;
an imaging sub-system including one or more imaging lenses and a detector configured to generate a sequence of images of the sample based on the first frequency comb and the second frequency comb;
one or more coding optical elements including at least one of one or more optical retarders or one or more polarizers, wherein at least one of the one or more coding optical elements is in the illumination sub-system, wherein at least one of the one or more coding optical elements is in the imaging sub-system, wherein the one or more coding optical elements encode data associated with one or more transfer matrix elements into the sequence of images of the sample, wherein the data associated with the one or more transfer matrix elements is encoded into at least one of a spatial domain, a spectral domain, or a time domain of the sequence of images; and
a controller including one or more processors configured to execute program instructions causing the one or more processors to:
generate a transfer matrix dataset including measurements of at least one of the one or more transfer matrix elements associated with the sample based on at least one of spatial, spectral, or temporal analysis of the sequence of images, wherein the transfer matrix dataset is at least one of spatially, spectrally, or temporally resolved; and
generate one or more measurements of the sample based on the transfer matrix dataset.

2. The measurement system of claim 1, wherein generate the transfer matrix dataset including the measurements of at least one of the one or more transfer matrix elements associated with the sample based on at least one of spatial, spectral, or temporal analysis of the sequence of images comprises:
decoding the at least one of the one or more transfer matrix elements from the sequence of images based on at least one of spatial, spectral, or frequency analysis of the sequence of images.

3. The measurement system of claim 1, wherein the one or more transfer matrix elements comprise:
Mueller matrix elements.

4. The measurement system of claim 1, wherein the one or more transfer matrix elements comprise:
Jones matrix elements.

5. The measurement system of claim 1, wherein the illumination sub-system further comprises:
a beam combiner configured to combine the first frequency comb and the second frequency comb into a single illumination beam, wherein the one or more imaging lenses of the illumination sub-system direct the single illumination beam to the sample.

6. The measurement system of claim 1, wherein the sequence of images correspond to multi-pixel images of the sample, wherein the transfer matrix dataset includes the measurements of at least one of the one or more transfer matrix elements as a function of wavelength and spatial location on the sample.

7. The measurement system of claim 1, wherein the sequence of images correspond to single-pixel images of the sample, wherein the transfer matrix dataset includes the measurements of at least one of the one or more transfer matrix elements as a function of wavelength for a single spatial location on the sample.

8. The measurement system of claim 1, wherein the one or more coding optical elements comprise:
a generator in the illumination sub-system, the generator comprising one or more beam-shearing plates to generate two or more sheared beams with different polarization states, wherein the one or more illumination lenses of the illumination sub-system direct the two or more sheared beams to a common spot on the sample; and
an analyzer in the imaging sub-system, the analyzer comprising one or more additional beam-shearing plates to shear the two or more sheared beams into additional sheared beams with different polarization states, wherein the one or more imaging lenses of the imaging sub-system interfere the additional sheared beams on the detector.

9. The measurement system of claim 8, wherein generate the transfer matrix dataset including the measurements of at least one of the one or more transfer matrix elements associated with the sample based on at least one of spectral or spatial frequency analysis of the sequence of images comprises:
generate, for a particular image of the sequence of images, one or more channel images based on a spatial frequency filtering technique; and
generate one or more transfer matrix element datasets based on the one or more channel images, wherein the transfer matrix dataset includes the one or more transfer Matrix element datasets.

10. The measurement system of claim 9, wherein the sequence of images comprises multi-pixel images, wherein the one or more transfer matrix element datasets comprise a sequence of spatially-resolved transfer matrix element images;
wherein generate the transfer matrix dataset including the measurements of at least one of the one or more transfer matrix elements associated with the sample based on at least one of a spatial, spectral, or temporal analysis of the sequence of images further comprises:
extract, for at least some pixels in the sequence of images, spectrally-resolved transfer matrix element data using a temporal frequency analysis technique, wherein the transfer matrix dataset includes the spectrally-resolved transfer matrix element data.

11. The measurement system of claim 1, wherein the one or more coding optical elements comprise:
a series of cascaded spectrally-dependent phase retarders to encode the data associated with the one or more transfer matrix elements into the spectral domain of the series of images.

12. The measurement system of claim 11, wherein the measurements of at least one of the one or more transfer matrix elements for each location on the sample are decoded by spectral analysis of the sequence of images.

13. The measurement system of claim 1, wherein the one or more coding optical elements comprise:
one or more rotating optical elements in at least one of the illumination sub-system or the imaging sub-system.

14. The measurement system of claim 13, wherein the one or more rotating optical elements comprise:
a first rotating quarter waveplate in the illumination sub-system; and
a second rotating quarter waveplate in the imaging sub-system, wherein the first rotating quarter waveplate and the second rotating quarter waveplate rotate at different speeds, where the data associated with the one or more transfer matrix elements is encoded into the time domain of the sequence of images.

15. The measurement system of claim 13, wherein the measurements of at least one of the one or more transfer matrix elements for each location on the sample are decoded by temporal frequency analysis of the sequence of images.

16. The measurement system of claim 1, wherein the imaging sub-system provides the sequence of images through electro-optical sampling.

17. The measurement system of claim 1, wherein the one or more measurements comprise:
one or more metrology measurements.

18. The measurement system of claim 1, wherein the one or more measurements comprise:
one or more inspection measurements.

19. A measurement system comprising:
a controller including one or more processors configured to execute program instructions causing the one or more processors to:
generate a transfer matrix dataset including measurements of one or more transfer matrix elements associated with a sample based on at least one of spatial, spectral or temporal analysis of a sequence of images, wherein the transfer matrix dataset is at least one of spatially resolved or spectrally resolved, wherein the sequence of images is generated by a measurement sub-system comprising:
a first frequency comb source configured to generate a first frequency comb;
a second frequency comb source configured to generate a second frequency comb with a different repetition rate than the first frequency comb, wherein the second frequency comb source is at least one of frequency or phase-locked to the first frequency comb source;
an illumination sub-system including one or more illumination lenses to direct an illumination beam including at least one of the first frequency comb or the second frequency comb to the sample;
an imaging sub-system including one or more imaging lenses and a detector configured to generate the sequence of images of the sample based on the first frequency comb and the second frequency comb; and
one or more coding optical elements including one or more optical retarders, wherein the one or more coding optical elements encode data associated with the one or more transfer matrix elements into the sequence of images of the sample, wherein the data associated with the one or more transfer matrix elements is encoded into at least one of a spatial domain, a spectral domain, or a time domain of the sequence of images; and
generate one or more measurements of the sample based on the transfer matrix dataset.

20. The measurement system of claim 19, wherein generate the transfer matrix dataset including the measurements of the one or more transfer matrix elements associated with the sample based on at least one of spatial, spectral, or temporal analysis of the sequence of images comprises:
decoding the one or more transfer matrix elements from the sequence of images based on at least one of spatial, spectral, or frequency analysis of the sequence of images.

21. The measurement system of claim 19, wherein the one or more transfer matrix elements comprise:
Mueller matrix elements.

22. The measurement system of claim 19, wherein the one or more transfer matrix elements comprise:
Jones matrix elements.

23. The measurement system of claim 19, wherein the illumination sub-system further comprises:
a beam combiner configured to combine the first frequency comb and the second frequency comb into a single illumination beam, wherein the one or more imaging lenses of the illumination sub-system direct the single illumination beam to the sample.

24. The measurement system of claim 19, wherein the sequence of images correspond to multi-pixel images of the sample, wherein the transfer matrix dataset includes the measurements of the one or more transfer matrix elements as a function of wavelength and spatial location on the sample.

25. The measurement system of claim 19, wherein the sequence of images correspond to single-pixel images of the sample, wherein the transfer matrix dataset includes the measurements of the one or more transfer matrix elements as a function of wavelength for a single spatial location on the sample.

26. The measurement system of claim 19, wherein the one or more coding optical elements comprise:
a generator in the illumination sub-system, the generator comprising one or more beam-shearing plates to generate two or more sheared beams with different polarization states, wherein the one or more illumination lenses of the illumination sub-system direct the two or more sheared beams to a common spot on the sample; and
an analyzer in the imaging sub-system, the analyzer comprising one or more additional beam-shearing plates to shear the two or more sheared beams into additional sheared beams with different polarization states, wherein the one or more imaging lenses of the imaging sub-system interfere the additional sheared beams on the detector.

27. The measurement system of claim 26, wherein generate the transfer matrix dataset including the measurements of the one or more transfer matrix elements associated with the sample based on at least one of spectral or spatial frequency analysis of the sequence of images comprises:
generate, for a particular image of the sequence of images, one or more channel images based on a spatial frequency filtering technique; and
generate one or more transfer matrix element datasets based on the one or more channel images, wherein the transfer matrix dataset includes the one or more transfer Matrix element datasets.

28. The measurement system of claim 27, wherein the sequence of images comprises multi-pixel images, wherein the one or more transfer matrix element datasets comprise a sequence of spatially-resolved transfer matrix element images;
wherein generate the transfer matrix dataset including the measurements of the one or more transfer matrix elements associated with the sample based on at least one of spatial, spectral, or temporal analysis of the sequence of images further comprises:
extract, for at least some pixels in the sequence of images, spectrally-resolved transfer matrix element data using a temporal frequency analysis technique, wherein the transfer matrix dataset includes the spectrally-resolved transfer matrix element data.

29. The measurement system of claim 19, wherein the one or more coding optical elements comprise:
a series of cascaded spectrally-dependent phase retarders to encode the data associated with the one or more transfer matrix elements into the spectral domain of the series of images.

30. The measurement system of claim 29, wherein the one or more transfer matrix elements for each location on the sample are decoded by spectral analysis of the sequence of images.

31. The measurement system of claim 19, wherein the one or more coding optical elements comprise:
one or more rotating optical elements in at least one of the illumination sub-system or the imaging sub-system.

32. The measurement system of claim 31, wherein the one or more rotating optical elements comprise:
a first rotating quarter waveplate in the illumination sub-system; and
a second rotating quarter waveplate in the imaging sub-system, wherein the first rotating quarter waveplate and the second rotating quarter waveplate rotate at different speeds, where the data associated with the one or more transfer matrix elements is encoded into the time domain of the sequence of images.

33. The measurement system of claim 31, wherein the one or more transfer matrix elements for each location on the sample are decoded by temporal frequency analysis of the sequence of images.

34. The measurement system of claim 19, wherein the imaging sub-system provides the sequence of images through electro-optical sampling.

35. The measurement system of claim 19, wherein the one or more measurements comprise:
one or more metrology measurements.

36. The measurement system of claim 19, wherein the one or more measurements comprise:
one or more inspection measurements.

37. A measurement method comprising:
generating a transfer matrix dataset including measurements of one or more transfer matrix elements associated with a sample based on at least one of spatial, spectral, or temporal analysis of a sequence of images of the sample, wherein the transfer matrix dataset is at least one of spatially, spectrally, or temporally resolved, wherein the sequence of images is generated by a measurement sub-system comprising:
a first frequency comb source configured to generate a first frequency comb;
a second frequency comb source configured to generate a second frequency comb with a different repetition rate than the first frequency comb, wherein the second frequency comb source is at least one of frequency or phase-locked to the first frequency comb source;
an illumination sub-system including one or more illumination lenses to direct an illumination beam including at least one of the first frequency comb or the second frequency comb to the sample;
an imaging sub-system including one or more imaging lenses and a detector configured to generate the sequence of images of the sample based on the first frequency comb and the second frequency comb; and
one or more coding optical elements including one or more optical retarders, wherein the one or more coding optical elements encode data associated with the one or more transfer matrix elements into the sequence of images of the sample, wherein the data associated with the one or more transfer matrix elements is encoded into at least one of a spatial domain, a spectral domain, or a time domain of the sequence of images; and
generating one or more measurements of the sample based on the transfer matrix dataset.
